(19) United States
(12) Patent Application Publication
(10) Pub. No.: US 2004/0072605 A1
(43) Pub. Date: Apr. 15, 2004

(54) Gaming machine, program and server

(75) Inventor: Hirobumi Toyoda, Tokyo (JP)

Correspondence Address: ALFRED A. STADNICKI, ANTONELLI, TERRY, STOUT & KRAUS, LLP, SUITE 1800, ARLINGTON, VA, 22209, US

(73) Assignee: ARUZE CO., LTD., TOKYO (JP)

(21) Appl. No.: 10/619,186

(22) Filed: Jul. 15, 2003

(30) Foreign Application Priority Data
Jul. 17, 2002 (JP) 2002-208864

(51) Int. Cl. A63F 13/00

(52) U.S. Cl. 463/16; 463/20

(57) ABSTRACT

A gaming machine for a bingo game or other game using a matrix card is provided, to which is added an element that enables a player to make a selection that can influence the game result. A gaming machine is provided wherein the designs of playing cards, etc., are used in the respective cells of the matrix card, a game is started after allowing the cells to be shifted by each player, and a predetermined benefit is provided to the player when all cells of a line are made effective by lotteries and a winning combination of a poker game, etc., is formed along the line.

### CROSS-REFERENCE TO RELATED APPLICATIONS

This application is based upon and claims the benefit of priority from the prior Japanese Patent Application No. 2002-208864 filed on July 17 in 2002, the entire contents of which are incorporated herein by reference.

### BACKGROUND OF THE INVENTION

1. Field of the Invention

This invention relates to a gaming machine, a program, and a server.

2. Related Art

A bingo game is played in parties and other events. In the bingo game, a card forming a matrix which has some numerals from 1 to 75 allocated to respective cells of the matrix with five rows aligned vertically and five columns aligned horizontally is used. In accordance with selection by a lottery, a hole is made in each cell if an allocated number to the cell matches a selected number at each lottery occasion so that a card holder wins the game if his card has holes made along a vertical, horizontal, or diagonal line first.

This bingo game is simple in rules and, unlike lottery methods with which the results become known in an instant, it provides such effects as keeping one in suspense when a hole cannot be opened quickly and the anticipation of completing a row with just one more hole, and is thus enjoyed by many people regardless of age or gender.

While bingo cards made of paper are usually used when the bingo game is played at a party, various computer gaming machines simulating the game have also been developed and are installed in many gaming halls and arcades.

The gaming machine, etc. described in Japanese Unexamined Patent Publication No. 2001-162046 can be given as an example of a bingo gaming machine that is installed in a game hall.

However, since the bingo game is simple in rules, its results are affected only by luck and it can be said that there is no intervention whatsoever of a player's judgment. Though a player may have a right to select a bingo card, if the numbers are just aligned randomly, the standard for this selection may be trivial. That is because I like this number, or because I feel that I can win with the second from the right, etc. It can thus be said that most players select cards randomly.

Strategy and other thought processes for influencing the result are thus unnecessary for a player playing a bingo game and a player thus leaves the game result up to luck. It is therefore not an overstatement to say that a player simply enjoys the process leading up to the result.

Although some entertainment may be made during such process, it can be readily imagined that there is popularity of various games that allow players to utilize their own skills even if they can affect the game result only to a small degree.

Japanese Patent No. 2579739 discloses an invention with which a cell shift is enabled in accordance with the making effective of the respective cells during a game. Players are thus enabled to make judgments for completing a line more quickly than was possible priorly.

However, such a judgment simply enables cells that have become effective at that point to concentrate in a single row, and since similar shifts are selected by everyone, differences in judgment do not arise among players and it was difficult to make the personality of player be reflected in the judgments.

### SUMMARY OF THE INVENTION

According to this invention, it is an object to provide, for a bingo game or another game using a matrix card, a gaming machine to which is added an element of a puzzle game that enables a player to make a selection that can influence the game result.

In another aspect of this invention, a gaming machine is provided, wherein the designs of playing cards and so on are used in the respective cells of a matrix card, such that a game is started after allowing the cells to be shifted by the decision of each player, and that the game is won when all cells of a single line are made effective by lotteries so that a winning combination of a poker game, etc., is formed along this line.

To be more specific, according to this invention the following is provided.

(1) In a gaming machine, wherein a symbol is indicated in each of the cells of a matrix comprising five rows and five columns and with which, when a symbol selected randomly by a lottery matches a symbol allocated to one of the above-mentioned cells, that cell becomes effective and a predetermined benefit is provided to a player in accordance with the conditions of the cells that have become effective as a result of repeating the above-mentioned lottery a predetermined number of times; a gaming machine comprising: a symbol allocation means, using the designs of a deck of playing cards as the above-mentioned symbols and allocating the symbols in all of the cells of the above-mentioned matrix; an outer peripheral cell shift means, shifting the symbol, displayed in one of the outer peripheral cells positioned adjacent to the outer periphery of the above-mentioned matrix, along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell; an inner peripheral cell shift means, shifting the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, along the above-mentioned outer peripheral cells to an inner peripheral cell adjacent to the above-mentioned inner peripheral cell, at the same time shifting the symbol displayed in the above-mentioned adjacent inner peripheral cell along the above-mentioned outer peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell; and a disbursement value determination means, carrying out a game using the matrix having symbols allocated in all of the above-mentioned cells by the above-mentioned symbol allocation means and, when all cells of a line, made up of cells that indicate a combination of symbols expressing a winning combination in a poker game, become effective, determining, in accordance with the above-mentioned winning combination, the magnitude of disbursement of game media or the multiplication factor of disbursement with respect to the quantity of game media betted by the above-mentioned player.

With the above-described invention of (1), by arranging a gaming machine, such as a so-called “bingo gaming machine,” in which cells of a matrix allocated to a player are made effective in accordance with a lottery, to have “a symbol allocation means, using the designs of a deck of playing cards as the above-mentioned symbols and allocating the symbols in all of the cells of the above-mentioned matrix; an outer peripheral cell shift means, shifting the symbol, displayed in one of the outer peripheral cells positioned adjacent to the outer periphery of the above-mentioned matrix, along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell; an inner peripheral cell shift means, shifting the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, along the above-mentioned outer peripheral cells to an inner peripheral cell adjacent to the above-mentioned inner peripheral cell, at the same time shifting the symbol displayed in the above-mentioned adjacent inner peripheral cell along the above-mentioned outer peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell; and a disbursement value determination means, carrying out a game using the matrix having symbols allocated in all of the above-mentioned cells by the above-mentioned symbol allocation means and, when all cells of a line, made up of cells that indicate a combination of symbols expressing a winning combination in a poker game, become effective, determining, in accordance with the above-mentioned winning combination, the magnitude of disbursement of game media or the multiplication factor of disbursement with respect to the quantity of game media betted by the above-mentioned player,” the fun of a “bingo game” of anticipating whether or not a line of effective cells will be completed can be combined with the fun of a “poker game” of changing the combinations of symbols displayed in effective cells to complete a winning combination along a line and change the quantity of game media disbursed upon completion of this line and the fun of a “puzzle game” of pondering how to shift the cells to form a winning combination by which a game media disbursement of high multiplication factor can be obtained, thereby enabling a new way of enjoying a game in which the aim is not just to complete any line among the plurality of lines in a given card in a “bingo game” but in which a winning combination can be completed by rearranging, according to rules, the symbols displayed on the card and the multiplication factor of disbursement with respect to the quantity of game media disbursed varies according to the winning combination of a completed line.

The bingo game has been played in parties and other events, and due to being simple in rules, it is enjoyed by many people regardless of age or gender. Though in an event, “bingo cards,” made of paper, are used in this “bingo game,” various computer gaming machines simulating this game have also been developed and are installed in many game halls.

However, since the “bingo game” is simple in rules, its results are affected only by luck and it can be said that there is no intervention whatsoever of a player's judgment. Though a player has the right of selection in selecting a “bingo card,” if the numbers are just aligned randomly, the standard for this selection will be a trivial one, such as “because I like this number” or “I feel that I can win with the second from the right,” etc.

For such a problem, Patent No. 2579739 proposes an invention with which the shift of cells is enabled in accordance with the making effective of the respective cells during a game. Players are thus enabled to make judgments for completing a line more quickly than was possible priorly.

However, such a judgment simply enables cells that have become effective at that point to concentrate in a single row, differences in judgment do not arise among players and it was difficult to make the personality of player be reflected in the judgments.

Thus as in the present invention, by arranging a game to proceed using the designs of a deck of playing cards in place of the numbers in the conventional “bingo game” and arranging so that when a line is completed and the combination of the corresponding symbols form a winning combination of a “poker game,” the quantity of game media disbursed is determined in accordance with this winning combination, the disbursed quantity of game media that a player can receive can be made to vary according to how cells are shifted in a selected matrix and the player can thus be made to ponder about the shift of the cells.

(2) In a gaming machine, wherein a symbol is indicated in each of the cells of a matrix, with which the number of cells making up a row is the same as the number of cells making up a column and with which when a symbol selected randomly by a lottery matches a symbol allocated to one of the above-mentioned cells, that cell becomes effective and a predetermined benefit is provided to a player in accordance with the conditions of the cells that have become effective as a result of repeating the above-mentioned lottery a predetermined number of times; a gaming machine comprising: a symbol allocation means, using the designs of a set of mahjong tiles as the above-mentioned symbols and allocating the symbols in all of the cells of the above-mentioned matrix; an outer peripheral cell shift means, shifting the symbol, display din one of the outer peripheral cells positioned adjacent to the outer periphery of the above-mentioned matrix, along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell; an inner peripheral cell shift means, shifting the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, along the above-mentioned outer peripheral cells to an inner peripheral cell adjacent to the above-mentioned inner peripheral cell, at the same time shifting the symbol displayed in the above-mentioned adjacent inner peripheral cell along the above-mentioned outer peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell; and a disbursement value determination means, carrying out a game using the matrix having symbols allocated in all of the above-mentioned cells by the above-mentioned symbol allocation means and, when all cells of a line, made up of cells that indicate a combination of symbols expressing a predetermined combination, become effective, determining, in accordance with the above-mentioned combination, the magnitude of disbursement of game media or the multiplication factor of disbursement with respect to the quantity of game media betted by the above-mentioned player.

With the above-described invention of (2), by arranging a gaming machine, such as a so-called “bingo gaming machine,” in which cells of a matrix allocated to a player are made effective in accordance with a lottery, to have “a symbol allocation means, using the designs of a set of mahjong tiles as the above-mentioned symbols and allocating the symbols in all of the cells of the above-mentioned matrix; an outer peripheral cell shift means, shifting the symbol, displayed in one of the outer peripheral cells positioned adjacent to the outer periphery of the above-mentioned matrix, along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell; an inner peripheral cell shift means, shifting the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, along the above-mentioned outer peripheral cells to an inner peripheral cell adjacent to the above-mentioned inner peripheral cell, at the same time shifting the symbol displayed in the above-mentioned adjacent inner peripheral cell along the above-mentioned outer peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell; and a disbursement value determination means, carrying out a game using the matrix having symbols allocated in all of the above-mentioned cells by the above-mentioned symbol allocation means and, when all cells of a line, made up of cells that indicate a combination of symbols expressing a predetermined combination, become effective, determining, in accordance with the above-mentioned combination, the magnitude of disbursement of game media or the multiplication factor of disbursement with respect to the quantity of game media betted by the above-mentioned player,” the fun of a “bingo game” of anticipating whether or not a line of effective cells will be completed can be combined with the fun of a “mahjong game” of the quantity of game media disbursed being determined according to a winning combination formed by a combination of symbols indicated by the effective cells and the fun of a “puzzle game” of pondering how to shift the cells to form a winning combination by which a game media disbursement of high multiplication factor can be obtained, thereby enabling a new way of enjoying a game in which the aim is not just to complete any line among the plurality of lines in a given card in a “bingo game” but in which a winning combination can be completed by rearranging, according to rules, the symbols displayed on the card and the multiplication factor of disbursement with respect to the quantity of game media disbursed varies according to the winning combination of a completed line and also enabling the provision of a new gaming machine that differs from the above-described invention of (1) in the designs and combinations of symbols that are winning combinations.

Since priorly, “bingo games” have been played in parties and other events, and due to being simple in rules, it is enjoyed by many people regardless of age or gender. Though in an event, “bingo cards,” made of paper, are used in this bingo game, various computer gaming machines simulating this game have also been developed and are installed in many game halls.

However, since the “bingo game” is simple in rules, its results are affected only by luck and it can be said that there is no intervention whatsoever of a player's judgment. Though a player has the right of selection in selecting a “bingo card,” if the numbers are just aligned randomly, the standard for this selection will be a trivial one, such as “because T like this number” or “I feel that I can win with the second from the right,” etc.

For such a problem, Patent No. 2579739 proposes an invention with which the shift of cells is enabled in accordance with the making effective of the respective cells during a game. Players are thus enabled to make judgments for completing a line more quickly than was possible priorly.

However, such a judgment simply enables cells that have become effective at that point to concentrate in a single row, differences in judgment do not arise among players and it was difficult to make the personality of player be reflected in the judgments.

Thus as in the present invention, by arranging a game to proceed using the designs of a set of mahjong tiles in place of the numbers in the conventional “bingo game” and using, for example, an eight-row by eight-column matrix, and arranging so that when a line is completed and the combination of the corresponding symbols form a combination that can be associated with a winning combination of mahjong, which is made up of a combination of two sets of three symbols each and a combination of a set of two of the same symbols, the disbursed quantity of game media that a player can receive can be made to vary according to how cells are shifted in a selected matrix and the player can thus be made to ponder about the shift of the cells.

(3) The gaming machine as set forth in (1) or (2), wherein the above-mentioned symbol allocation means makes the above-mentioned symbols be aligned so that, depending on the results of shift of the above-mentioned outer peripheral cells and the above-mentioned inner peripheral cells by the above-mentioned outer peripheral cell shift means and inner peripheral cell shift means, a combination of symbols, among a plurality of poker game winning combinations that enable the provision of benefit to an above-mentioned player in the form of a quantity of game media disbursed or a multiplication factor of disbursement with respect to the quantity of game media betted by the above-mentioned player of a predetermined standard or more, will be aligned in at least one or more of the above-mentioned plurality of lines.

With the above-described invention of (3), by arranging the gaming machine as set forth in (1) or (2) so that “the above-mentioned symbol allocation means aligns the above-mentioned symbols so that, depending on the results of shift of the above-mentioned outer peripheral cells and the above-mentioned inner peripheral cells by the above-mentioned outer peripheral cell shift means and inner peripheral cell shift means, a combination of symbols, among a plurality of poker game winning combinations that enable the provision of benefit to an above-mentioned player in the form of a quantity of game media disbursed or a multiplication factor of disbursement with respect to the quantity of game media betted by the above-mentioned player of a predetermined standard or more, will be aligned in at least one or more of the above-mentioned plurality of lines,” it becomes possible for a player to always anticipate the provision of benefit of a certain level or more.

With the gaming machine of (1), since a matrix presented to a player is arranged with randomly selected playing card designs being aligned, though on one hand, a player can enjoy the fun of a “puzzle game,” on the other hand, depending on the result of selection of the designs, no winning combinations may be completed at all no matter how the cells are shifted or even if a winning combination is completed, the winning combination may be a “one pair,” “two pairs,” or other winning combination that is low in the quantity of game media disbursed or low in the multiplication factor of disbursement with respect to the quantity of game media betted by the above-mentioned player.

Thus by arranging, as in the present invention, so that a winning combination, which enables the provision of benefit to an above-mentioned player in the form of a quantity of game media disbursed or a multiplication factor of disbursement with respect to the quantity of game media betted by the above-mentioned player of a predetermined standard or more, will always be included in the matrix presented to the above-mentioned player, it becomes possible for a player to anticipate the provision of benefit of a certain level or more not matter which card the player chooses and the player's interest can thus be drawn further.

(4) The gaming machine as set forth in any of (1) to (3), comprising: a valid line determination means, which determines, in accordance with the quantity of game media betted by a player, the number and positions of lines, among the above-mentioned plurality of lines, with which disbursement of game media can be carried out when all cells aligned therein become effective.

With the above-described invention of (4), by arranging the gaming machine as set forth in any of (1) to (3) so as to have “a valid line determination means, which determines, in accordance with the quantity of game media betted by a player, the number and positions of lines, among the above-mentioned plurality of lines, with which disbursement of game media can be carried out when all cells aligned therein become effective,” it becomes possible to select the number of lines subject to betting (shall be referred to hereinafter as “effective” where suitable) in accordance with the quantity of game media betted by a player and adjust the quantity of game media betted in accordance with the magnitude of the multiplication factor of disbursement upon completion of lines, thus enabling the selection of a player to have a large influence on the game result.

With a conventional “bingo game,” it was sufficient for any one of the vertical, horizontal, and diagonal lines to be completed.

However, with the game by this invention, since not only must a line be simply be completed but the multiplication factor of disbursement of game media varies according to the combination of symbols in the completed line, the value of a line for a player will differ among lines with which a high disbursement multiplication factor can be anticipated, lines with which a low disbursement multiplication factor can be anticipated, and lines with which no disbursement can be anticipated.

Thus with this invention, by making not the entirety of a single matrix be a subject of betting but by making each line among a plurality of lines in a single matrix be a subject of betting, the ranges of a player's selection and strategy are expanded and the provision of a gaming machine that is more interesting is enabled.

For example, a selection, such as betting a single coin, which is game media, on a line having a “four card” as a winning combination, betting five coins on a line having a “two pairs” as a winning combination, and not betting even a single coin on another line having a “one pair” as a winning combination, is enabled.

(5) The gaming machine as set forth in any of (1) to (4), comprising: a prior cell effective means, which makes a part of the cells of the above-mentioned matrix effective in accordance with a lottery.

With the above-described invention of (5), by arranging the gaming machine as set forth in any of (1) to (4) so as to have “a prior cell effective means, which makes a part of the cells of the above-mentioned matrix effective in accordance with a lottery,” the shortening of the game time by quick completion of a line can be anticipated and a player can be made to anticipate ease of completion of a line.

In the original “poker game,” with the exception of special winning combinations, various hand card combinations that can make up a winning combination exist. For example, in the case of “two pairs,” as long as the four cards that form two pairs are determined, the remaining card may be any card.

However, with the game by this invention, since the positions of the symbols are determined in advance and since all of the symbols indicated in five cells of a line must be made effective no matter what winning combination the combination along the line forms, a large number of lotteries is required to complete a line.

Thus with this invention, by making a part of the cells effective by a lottery in advance and thereby enabling the line, having these cells that have been made effective, to be completed by the making effective the cells besides these effective cells, the shortening of the game time can be anticipated. Also a player can be made to anticipate early completion of the line, thus enabling the interest of the player to be drawn.

Also since in the case where the designs of mahjong tiles are used as in the gaming machine of (2), the number of cells can become large in comparison to the gaming machine of (1), this invention enables the progress of the game to be quickened.

(6) In a gaming machine, wherein a symbol is indicated in each of the cells of a matrix comprising five rows and five columns and with which when a symbol selected randomly by a lottery matches a symbol allocated to one of the above-mentioned cells, that cell becomes effective and a predetermined benefit is provided to a player in accordance with the conditions of the cells that have become effective as a result of repeating the above-mentioned lottery a predetermined number of times; a gaming machine characterized in that the designs of a deck of playing cards are used as the above-mentioned symbols, the symbols are allocated in all of the cells of the above-mentioned matrix, the symbol, displayed in one of the outer peripheral cells positioned adjacent to the outer periphery of the above-mentioned matrix, is shifted along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell and these processes are executed on all outer peripheral cells so that for each of all outer peripheral cells, the symbol displayed in the outer peripheral cell is shifted to an outer peripheral cell adjacent to said outer peripheral cell, the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, is shifted along the above-mentioned outer peripheral cells to an inner peripheral cell adjacent to the above-mentioned inner peripheral cell at the same time shifting the symbol displayed in the above-mentioned adjacent inner peripheral cell along the above-mentioned outer peripheral cells to yet another adjacent inner peripheral cell and these processes are executed on all inner peripheral cells so that for each of all inner peripheral cells, the symbol displayed in the inner peripheral cell is shifted to an inner peripheral cell adjacent to said inner peripheral cell, a game is carried out using the matrix obtained by the above-mentioned positioning, and, when all cells of a line, made up of cells that indicate a combination of symbols expressing a winning combination in a poker game, become effective, the magnitude of disbursement of game media or the multiplication factor of disbursement with respect to the quantity of game media betted by the above-mentioned player is determined according to the above-mentioned winning combination.

With the above-described invention of (6), by arranging a gaming machine, such as a so-called “bingo gaming machine,” in which cells of a matrix allocated to a player are made effective in accordance with a lottery, so that “the designs of a deck of playing cards are used as the above-mentioned symbols, the symbols are allocated in all of the cells of the above-mentioned matrix, the symbol, displayed in one of the outer peripheral cells positioned adjacent to the outer periphery of the above-mentioned matrix, is shifted along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell and these processes are executed on all outer peripheral cells so that for each of all outer peripheral cells, the symbol displayed in the outer peripheral cell is shifted to an outer peripheral cell adjacent to said outer peripheral cell, the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, is shifted along the above-mentioned outer peripheral cells to an inner peripheral cell adjacent to the above-mentioned inner peripheral cell at the same time shifting the symbol displayed in the above-mentioned adjacent inner peripheral cell along the above-mentioned outer peripheral cells to yet another adjacent inner peripheral cell and these processes are executed on all inner peripheral cells so that for each of all inner peripheral cells, the symbol displayed in the inner peripheral cell is shifted to an inner peripheral cell adjacent to said inner peripheral cell, a game is carried out using the matrix obtained by the above-mentioned positioning, and, when all cells of a line, made up of cells that indicate a combination of symbols expressing a winning combination in a poker game, become effective, the magnitude of disbursement of game media or the multiplication factor of disbursement with respect to the quantity of game media betted by the above-mentioned player is determined according to the above-mentioned winning combination,” the fun of a “bingo game” of anticipating whether or not a line of effective cells will be completed can be combined with the fun of a “poker game” of changing the combinations of symbols displayed in effective cells to complete a winning combination along a line and change the quantity of game media disbursed upon completion of this line and the fun of a “puzzle game” of pondering how to shift the cells to form a winning combination by which a game media disbursement of high multiplication factor can be obtained, thereby enabling a new way of enjoying a game in which the aim is not just to complete any line among the plurality of lines in a given card in a “bingo game” but in which a winning combination can be completed by rearranging, according to rules, the symbols displayed on the card and the multiplication factor of disbursement with respect to the quantity of game media disbursed varies according to the winning combination of a completed line.

Since priorly, “bingo games” have been played in parties and other events, and due to being simple in rules, it is enjoyed by many people regardless of age or gender. Though in an event, “bingo cards,” made of paper, are used in this bingo game, various computer gaming machines simulating this game have also been developed and are installed in many game halls.

However, since the “bingo game” is simple in rules, its results are affected only by luck and it can be said that there is no intervention whatsoever of a player's judgment. Though a player has the right of selection in selecting a “bingo card,” if the numbers are just aligned randomly, the standard for this selection will be a trivial one, such as “because I like this number” or “I feel that I can win with the second from the right,” etc.

For such a problem, Patent No. 2579739 proposes an invention with which the shift of cells is enabled in accordance with the making effective of the respective cells during a game. Players are thus enabled to make judgments for completing a line more quickly than was possible priorly.

However, such a judgment simply enables cells that have become effective at that point to concentrate in a single row, differences in judgment do not arise among players and it was difficult to make the personality of player be reflected in the judgments.

Thus as in the present invention, by arranging a game to proceed using the designs of a deck of playing cards in place of the numbers in the conventional “bingo game” and arranging so that when a line is completed and the combination of the corresponding symbols form a winning combination of a “poker game,” the quantity of game media disbursed is determined in accordance with this winning combination, the disbursed quantity of game media that a player can receive can be made to vary according to how cells are shifted in a selected matrix and the player can thus be made to ponder about the shift of the cells

According to this invention, the following may be provided.

In a gaming machine, wherein a symbol is indicated in each of the cells of a matrix, with which the number of cells making up a row is the same as the number of cells making up a column and with which when a symbol selected randomly by a lottery matches a symbol allocated to one of the above-mentioned cells, that cell becomes effective and a predetermined benefit is provided to a player in accordance with the conditions of the cells that have become effective as a result of repeating the above-mentioned lottery a predetermined number of times; a gaming machine characterized in that the designs of a deck of playing cards are used as the above-mentioned symbols, the symbols are allocated in all of the cells of the above-mentioned matrix, the symbol, displayed in one of the outer peripheral cells positioned adjacent to the outer periphery of the above-mentioned matrix, is shifted along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell and these processes are executed on all outer peripheral cells so that for each of all outer peripheral cells, the symbol displayed in the outer peripheral cell is shifted to an outer peripheral cell adjacent to said outer peripheral cell, the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, is shifted along the above-mentioned outer peripheral cells to an inner peripheral cell adjacent to the above-mentioned inner peripheral cell at the same time shifting the symbol displayed in the above-mentioned adjacent inner peripheral cell along the above-mentioned outer peripheral cells to yet another adjacent inner peripheral cell and these processes are executed on all inner peripheral cells so that for each of all inner peripheral cells, the symbol displayed in the inner peripheral cell is shifted to an inner peripheral cell adjacent to said inner peripheral cell, a game is carried out using the matrix obtained by the above-mentioned positioning, and, when all cells of a line, made up of cells that indicate a combination of symbols expressing a predetermined combination, become effective, the magnitude of disbursement of game media or the multiplication factor of disbursement with respect to the quantity of game media betted by the above-mentioned player is determined according to the above-mentioned combination.

With the above-described invention, by arranging a gaming machine, such as a so-called “bingo gaming machine,” in which cells of a matrix allocated to a player are made effective in accordance with a lottery, so that “the designs of a set of mahjong tiles are used as the above-mentioned symbols, the symbols are allocated in all of the cells of the above-mentioned matrix, the symbol, displayed in one of the outer peripheral cells positioned adjacent to the outer periphery of the above-mentioned matrix, is shifted along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell and these processes are executed on all outer peripheral cells so that for each of all outer peripheral cells, the symbol displayed in the outer peripheral cell is shifted to an outer peripheral cell adjacent to said outer peripheral cell, the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, is shifted along the above-mentioned outer peripheral cells to an inner peripheral cell adjacent to the above-mentioned inner peripheral cell at the same time shifting the symbol displayed in the above-mentioned adjacent inner peripheral cell along the above-mentioned outer peripheral cells to yet another adjacent inner peripheral cell and these processes are executed on all inner peripheral cells so that for each of all inner peripheral cells, the symbol displayed in the inner peripheral cell is shifted to an inner peripheral cell adjacent to said inner peripheral cell, a game is carried out using the matrix obtained by the above-mentioned positioning, and, when all cells of a line, made up of cells that indicate a combination of symbols expressing a predetermined combination, become effective, the magnitude of disbursement of game media or the multiplication factor of disbursement with respect to the quantity of game media betted by the above-mentioned player is determined according to the above-mentioned combination,” the fun of a “bingo game” of anticipating whether or not a line of effective cells will be completed can be combined with the fun of a “mahjong game” of changing the combinations of symbols displayed in effective cells to complete a winning combination along a line and change the quantity of game media disbursed upon completion of this line and the fun of a “puzzle game” of pondering how to shift the cells to form a winning combination by which a game media disbursement of high multiplication factor can be obtained, thereby enabling a new way of enjoying a game in which the aim is not just to complete any line among the plurality of lines in a given card in a “bingo game” but in which a winning combination can be completed by rearranging, according to rules, the symbols displayed on the card and the multiplication factor of disbursement with respect to the quantity of game media disbursed varies according to the winning combination of a completed line.

(7) In a program used in a gaming machine, wherein a symbol is indicated in each of the cells of a matrix comprising five rows and five columns and with which, when a symbol selected randomly by a lottery matches a symbol allocated to one of the above-mentioned cells, that cell becomes effective and a predetermined benefit is provided to a player in accordance with the conditions of the cells that have become effective as a result of repeating the above-mentioned lottery a predetermined number of times; a program characterized in making the gaming machine execute: a symbol allocating step of using the designs of a deck of playing cards as the above-mentioned symbols and making the symbols be allocated in all of the cells of the above-mentioned matrix; an outer peripheral cell shift step of shifting the symbol, displayed in one of the outer peripheral cells positioned adjacent to the outer periphery of the above-mentioned matrix, along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell; an inner peripheral cell shift step of shifting the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, along the above-mentioned outer peripheral cells to an inner peripheral cell adjacent to the above-mentioned inner peripheral cell, at the same time shifting the symbol displayed in the above-mentioned adjacent inner peripheral cell along the above-mentioned outer peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell; and a disbursement value determination step of carrying out a game using the matrix having symbols allocated in all of the above-mentioned cells in the above-mentioned symbol allocating step and, when all cells of a line, made up of cells that indicate a combination of symbols expressing a winning combination in a poker game, become effective, making the magnitude of disbursement of game media or the multiplication factor of disbursement with respect to the quantity of game media betted by the above-mentioned player be determined in accordance with the above-mentioned winning combination.

With the above-described invention of (7), by arranging for a gaming machine, such as a so-called “bingo gaming machine,” in which cells of a matrix allocated to a player are made effective in accordance with a lottery, a program that makes the gaming machine execute “a symbol allocating step of using the designs of a deck of playing cards as the above-mentioned symbols and making the symbols be allocated in all of the cells of the above-mentioned matrix; an outer peripheral cell shift step of shifting the symbol, displayed in one of the outer peripheral cells positioned adjacent to the outer periphery of the above-mentioned matrix, along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell; an inner peripheral cell shift step of shifting the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, along the above-mentioned outer peripheral cells to an inner peripheral cell adjacent to the above-mentioned inner peripheral cell, at the same time shifting the symbol displayed in the above-mentioned adjacent inner peripheral cell along the above-mentioned outer peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell; and a disbursement value determination step of carrying out a game using the matrix having symbols allocated in all of the above-mentioned cells in the above-mentioned symbol allocating step and, when all cells of a line, made up of cells that indicate a combination of symbols expressing a winning combination in a poker game, become effective, making the magnitude of disbursement of game media or the multiplication factor of disbursement with respect to the quantity of game media betted by the above-mentioned player be determined in accordance with the above-mentioned winning combination,” the fun of a “bingo game” of anticipating whether or not a line of effective cells will be completed can be combined with the fun of a “poker game” of changing the combinations of symbols displayed in effective cells to complete a winning combination along a line and change the quantity of game media disbursed upon completion of this line and the fun of a “puzzle game” of pondering how to shift the cells to form a winning combination by which a game media disbursement of high multiplication factor can be obtained, thereby enabling a new way of enjoying a game in which the aim is not just to complete any line among the plurality of lines in a given card in a “bingo game” but in which a winning combination can be completed by rearranging, according to rules, the symbols displayed on the card and the multiplication factor of disbursement with respect to the quantity of game media disbursed varies according to the winning combination of a completed line.

Since priorly, “bingo games” have been played in parties and other events, and due to being simple in rules, it is enjoyed by many people regardless of age or gender. Though in an event, “bingo cards,” made of paper, are used in this bingo game, various computer gaming machines simulating this game have also been developed and are installed in many game halls.

However, since the “bingo game” is simple in rules, its results are affected only by luck and it can be said that there is no intervention whatsoever of a player's judgment. Though a player has the right of selection in selecting a “bingo card,” if the numbers are just aligned randomly, the standard for this selection will be a trivial one, such as “because I like this number” or “I feel that I can win with the second from the right,” etc.

For such a problem, Patent No. 2579739 proposes an invention with which the shift of cells is enabled in accordance with the making effective of the respective cells during a game. Players are thus enabled to make judgments for completing a line more quickly than was possible priorly.

However, such a judgment simply enables cells that have become effective at that point to concentrate in a single row, differences in judgment do not arise among players and it was difficult to make the personality of player be reflected in the judgments.

Thus as in the present invention, by arranging a program to make a game proceed using the designs of a deck of playing cards in place of the numbers in the conventional “bingo game” and so that when a line is completed and the combination of the corresponding symbols form a winning combination of a“poker game,” the quantity of game media disbursed is determined in accordance with this winning combination, the disbursed quantity of game media that a player can receive can be made to vary according to how cells are shifted in a selected matrix and the player can thus be made to ponder about the shift of the cells.

According to this invention, the following may also be provided.

In a program used in a gaming machine, wherein a symbol is indicated in each of the cells of a matrix, with which the number of cells making up a row is the same as the number of cells making up a column and with which when a symbol selected randomly by a lottery matches a symbol allocated to one of the above-mentioned cells, that cell becomes effective and a predetermined benefit is provided to a player in accordance with the conditions of the cells that have become effective as a result of repeating the above-mentioned lottery a predetermined number of times; a program characterized in making the gaming machine execute: a symbol allocating step of using the designs of a set of mahjong tiles as the above-mentioned symbols and making the symbols be allocated in all of the cells of the above-mentioned matrix; an outer peripheral cell shift step of shifting the symbol, displayed in one of the outer peripheral cells positioned adjacent to the outer periphery of the above-mentioned matrix, along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell; an inner peripheral cell shift step of shifting the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, along the above-mentioned outer peripheral cells to an inner peripheral cell adjacent to the above-mentioned inner peripheral cell, at the same time shifting the symbol displayed in the above-mentioned adjacent inner peripheral cell along the above-mentioned outer peripheral cells to yet another adjacent inner peripheral cell, and executing thes processes on all inner peripheral cells so that for each of all inner peripheral cells, the symbol displayed in the inner peripheral cell is shifted to an inner peripheral cell adjacent to said inner peripheral cell; and a disbursement value determination step of carrying out a game using the matrix having symbols allocated in all of the above-mentioned cells by the above-mentioned positioning and, when all cells of a line, made up of cells that indicate a combination of symbols expressing a predetermined combination, become effective, making the magnitude of disbursement of game media or the multiplication factor of disbursement with respect to the quantity of game media betted by the above-mentioned player be determined in accordance with the above-mentioned combination.

With the above-described invention, by arranging for a gaming machine, such as a so-called “bingo gaming machine,” in which cells of a matrix allocated to a player are made effective in accordance with a lottery, a program that makes the gaming machine “execute; a symbol allocating step of making the designs of a set of mahjong tiles be used as the above-mentioned symbols and making the symbols be allocated in all of the cells of the above-mentioned matrix; an outer peripheral cell shift means for shifting the symbol, displayed in one of the outer peripheral cells positioned adjacent to the outer periphery of the above-mentioned matrix, along the outer periphery of the above-mention d matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell; an inner peripheral cell shift step of shifting the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, along th above-mentioned outer peripheral cells to an inner peripheral cell adjacent to the above-mentioned inner peripheral cell, at the same time shifting the symbol displayed in the above-mentioned adjacent inner peripheral cell along the above-mentioned outer peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell; and a disbursement value determination step of carrying out a game using the matrix having symbols allocated in all of the above-mentioned cells by the above-mentioned positioning and, when all cells of a line, made up of cells that indicate a combination of symbols expressing a predetermined combination, become effective, making the magnitude of disbursement of game media or the multiplication factor of disbursement with respect to the quantity of game media betted by the above-mentioned player be determined in accordance with the above-mentioned combination,” the fun of a “bingo game” of anticipating whether or not a line of effective cells will be completed can be combined with the fun of a “mahjong game” of changing the combinations of symbols displayed in effective cells to complete a winning combination along a line and change the quantity of game media disbursed upon completion of this line and the fun of a “puzzle game” of pondering how to shift the cells to form a winning combination by which a game media disbursement of high multiplication factor can be obtained, thereby enabling a new way of enjoying a game in which the aim is not just to complete any line among the plurality of lines in a given card in a “bingo game” but in which a winning combination can be completed by rearranging, according to rules, the symbols displayed on the card and the multiplication factor of disbursement with respect to the quantity of game media disbursed varies according to the winning combination of a completed line.

(8) In a server, connectable via a communication line to and controlling gaming machines so that with each gaming machine, a symbol is indicated in each of the cells of a matrix comprising five rows and five columns and with which, when a symbol selected randomly by a lottery matches a symbol allocated to one of the above-mentioned cells, that cell becomes effective and a predetermined benefit is provided to a player in accordance with the conditions of the cells that have become effective as a result of repeating the above-mentioned lottery a predetermined number of times; a server comprising; a symbol allocation means, using the designs of a deck of playing cards as the above-mentioned symbols and making the symbols be allocated in all of the cells of the above-mentioned matrix; an outer peripheral cell shift means, making the symbol, displayed in one of the outer peripheral cells positioned adjacent to the outer periphery of the above-mentioned matrix, be shifted along the outer periphery of the above-mentioned matrix to an outer peripheral cell adjacent to the above-mentioned outer peripheral cell, at the same time making the symbol displayed in the above-mentioned adjacent outer peripheral cell be shifted along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell; an inner peripheral cell shift means, making the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, be shifted along the above-mentioned outer peripheral cells to an inner peripheral cell adjacent to the above-mentioned inner peripheral cell, at the same time making the symbol displayed in the above-mentioned adjacent inner peripheral cell be shifted along the above-mentioned outer peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell; and a disbursement value determination means, carrying out a game using the matrix having symbols allocated in all of the above-mentioned cells by the above-mentioned symbol allocation means and, when all cells of a line, made up of cells that indicate a combination of symbols expressing a winning combination in a poker game, become effective, making the magnitude of disbursement of game media or the multiplication factor of disbursement with respect to the quantity of game media betted by the above-mentioned player be determined in accordance with the above-mentioned winning combination.

With the above-described invention of (8), by arranging a server, which controls gaming machines, such as a so-called “bingo gaming machine,” wherein cells of a matrix allocated to a player are made effective in accordance with a lottery, to have “a symbol allocation means, using the designs of a deck of playing cards as the above-mentioned symbols and making the symbols be allocated in all of the cells of the above-mentioned matrix; an outer peripheral cell shift means, making the symbol, displayed in one of the outer peripheral cells positioned adjacent to the outer periphery of the above-mentioned matrix, be shifted along the outer periphery of the above-mentioned matrix to an outer peripheral cell adjacent to the above-mentioned outer peripheral cell, at the same time making the symbol displayed in the above-mentioned adjacent outer peripheral cell be shifted along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell; an inner peripheral cell shift means, making the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, be shifted along the above-mentioned outer peripheral cells to an inner peripheral cell adjacent to the above-mentioned inner peripheral cell, at the same time making the symbol displayed in the above-mentioned adjacent inner peripheral cell be shifted along the above-mentioned outer peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell; and a disbursement value determination means, carrying out a game using the matrix having symbols allocated in all of the above-mentioned cells by the above-mentioned symbol allocation means and, when all cells of a line, made up of cells that indicate a combination of symbols expressing a winning combination in a poker game, become effective, making the magnitude of disbursement of game media or the multiplication factor of disbursement with respect to the quantity of game media betted by the above-mentioned player be determined in accordance with the above-mentioned winning combination,” the fun of a “bingo game” of anticipating whether or not a line of effective cells will be completed can be combined with the fun of a “poker game” of changing the combinations of symbols displayed in effective cells to complete a winning combination along a line and change the quantity of game media disbursed upon completion of this line and the fun of a “puzzle game” of pondering how to shift the cells to forma winning combination by which a game media disbursement of high multiplication factor can be obtained, thereby enabling a new way of enjoying a game in which the aim is not just to complete any line among the plurality of lines in a given card in a “bingo game” but in which a winning combination can be completed by rearranging, according to rules, the symbols displayed on the card and the multiplication factor of disbursement with respect to the quantity of game media disbursed varies according to the winning combination of a completed line.

Since priorly, “bingo games” have been played in parties and other events, and due to being simple in rules, it is enjoyed by many people regardless of age or gender. Though in an event, “bingo cards,” made of paper, are used in this bingo game, various computer gaming machines simulating this game have also been developed and are installed in many game halls.

However, since the “bingo game” is simple in rules, its results are affected only by luck and it can be said that there is no intervention whatsoever of a player's judgment. Though a player has the right of selection in selecting a “bingo card,” if the numbers are just aligned randomly, the standard for this selection will be a trivial one, such as “because I like this number” or “I feel that I can win with the second from the right,” etc.

For such a problem, Patent No. 2579739 proposes an invention with which the shift of cells is enabled in accordance with the making effective of the respective cells during a game. Players are thus enabled to make judgments for completing a line more quickly than was possible priorly.

However, such a judgment simply enables cells that have become effective at that point to concentrate in a single row, differences in judgment do not arise among players and it was difficult to make the personality of player be reflected in the judgments.

Thus as in the present invention, by arranging a server to make a game proceed using the designs of a deck of playing cards in place of the numbers in the conventional “bingo game” and so that when a line is completed and the combination of the corresponding symbols form a winning combination of a “poker game,” the quantity of game media disbursed is determined in accordance with this winning combination, the disbursed quantity of game media that a player can receive can be made to vary according to how cells are shifted in a selected matrix and the player can thus be made to ponder about the shift of the cells.

According to this invention, the following may also be provided.

In a server, connectable via a communication line to and controlling gaming machines so that with each gaming machine, a symbol is indicated in each of the cells of a matrix, with which the number of cells making up a row is the same as the number of cells making up a column and with which, when a symbol selected randomly by a lottery matches a symbol allocated to one of the above-mentioned cells, that cell becomes effective and a predetermined benefit is provided to a player in accordance with the conditions of the cells that have become effective as a result of repeating the above-mentioned lottery a predetermined number of times; a server comprising; a symbol allocation means, using the designs of a set of mahjong tiles as the above-mentioned symbols and making the symbols be allocated in all of the cells of the above-mentioned matrix; an outer peripheral cell shift means, making the symbol, displayed in one of the outer peripheral cells positioned adjacent to the outer periphery of the above-mentioned matrix, be shifted along the outer periphery of the above-mentioned matrix to an outer peripheral cell adjacent to the above-mentioned outer peripheral cell, at the same time making the symbol displayed in the above-mentioned adjacent outer peripheral cell be shifted along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell; an inner peripheral cell shift means, making the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, be shifted along the above-mentioned outer peripheral cells to an inner peripheral cell adjacent to the above-mentioned inner peripheral cell, at the same time making the symbol displayed in the above-mentioned adjacent inner peripheral cell be shifted along the above-mentioned outer peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell; and a disbursement value determination means, carrying out a game using the matrix having symbols allocated in all of the above-mentioned cells by the above-mentioned symbol allocation means and, when all cells of a line, made up of cells that indicate a combination of symbols expressing a predetermined combination, become effective, making the magnitude of disbursement of game media or the multiplication factor of disbursement with respect to the quantity of game media betted by the above-mentioned player be determined in accordance with the above-mentioned combination.

With the above-described invention, by arranging a server, which controls gaming machines, such as a so-called “bingo gaming machine,” wherein cells of a matrix allocated to a player are made effective in accordance with a lottery, to have “a symbol allocation means, using the designs of a deck of playing cards as the above-mentioned symbols and making the symbols be allocated in all of the cells of the above-mentioned matrix; an outer peripheral cell shift means, making the symbol, displayed in one of the outer peripheral cells positioned adjacent to the outer periphery of the above-mentioned matrix, be shifted along the outer periphery of the above-mentioned matrix to an outer peripheral cell adjacent to the above-mentioned outer peripheral cell, at the same time making the symbol displayed in the above-mentioned adjacent outer peripheral cell be shifted along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell; an inner peripheral cell shift means, making the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, be shifted along the above-mentioned outer peripheral cells to an inner peripheral cell adjacent to the above-mentioned inner peripheral cell, at the same time making the symbol displayed in the above-mentioned adjacent inner peripheral cell be shifted along the above-mentioned outer peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell; and a disbursement value determination means, carrying out a game using the matrix having symbols allocated in all of the above-mentioned cells by the above-mentioned symbol allocation means and, when all cells of a line, made up of cells that indicate a combination of symbols expressing a winning combination in a poker game, become effective, making the magnitude of disbursement of game media or the multiplication factor of disbursement with respect to the quantity of game media betted by the above-mentioned player be determined in accordance with the above-mentioned winning combination,” the fun of a “bingo game” of anticipating whether or not a line of effective cells will be completed can be combined with the fun of a “poker game” of changing the combinations of symbols displayed in effective cells to complete a winning combination along a line and change the quantity of game media disbursed upon completion of this line and the fun of a “puzzle game” of pondering how to shift the cells to form a winning combination by which a game media disbursement of high multiplication factor can be obtained, thereby enabling a new way of enjoying a game in which the aim is not just to complete any line among the plurality of lines in a given card in a “bingo game” but in which a winning combination can be completed by rearranging, according to rules, the symbols displayed on the card and the multiplication factor of disbursement with respect to the quantity of game media disbursed varies according to the winning combination of a completed line.

In the description, a line may refer to a set of cells that are aligned along a straight line in a row direction, a column direction, or a diagonal direction of the matrix. The number of cells contained in this set matches the number of rows or columns of the matrix.

Completion of the line may refer to the state where all symbols indicated in cells along the line have been made effective according to lottery results.

Furthermore, a winning combination may refer to a state where a certain combination of symbols is a specific combination that satisfies conditions that have been determined in advance. By way of example, one pair, full house, royal straight flush, etc. may be included in a poker game.

Further features of the invention, its nature and various advantages will be more apparent from the accompanying drawing and the following detailed description of the invention.

### BRIEF DESCRIPTION OF THE DRAWINGS

FIG. 1 is a perspective view showing a general appearance of a gaming machine according to an embodiment of the present invention.

FIG. 2 is an enlarged front view of the vicinity of a display device of the gaming machine of the embodiment according to the present invention.

FIG. 3 is a block diagram showing the main control circuit of a gaming machine of an embodiment according to the present invention.

FIG. 4 is a schematic view illustrating a recording way of lottery results of the gaming machine according to the present invention.

FIG. 5 shows a data sheet indicating a correspondence between symbol codes and symbols used in the gaming machine of an embodiment according to the present invention.

FIG. 6 is a block diagram showing a display control device of the gaming machine of an embodiment according to the present invention.

FIG. 7 is a schematic view of a screen display of the gaming machine of an embodiment according to the present invention.

FIG. 8A is a schematic view of a screen display of the gaming machine of an embodiment according to the present invention.

FIG. 8B is a schematic view of a screen display of the gaming machine of the embodiment according to the present invention.

FIG. 8C is a schematic view of a screen display of the gaming machine of the embodiment according to the present invention.

FIG. 9 is a schematic view of a screen display of the gaming machine of an embodiment according to the present invention.

FIG. 10 is a schematic view of a screen display of the gaming machine of the embodiment according to the present invention.

FIG. 11 is a schematic view of a screen display of the gaming machine of the embodiment according to the present invention.

FIG. 12 is a schematic view of a screen display of the gaming machine of the embodiment according to the present invention.

FIG. 13 is a schematic view of a screen display of the gaming machine of an embodiment according to the present invention.

FIG. 14 is a flowchart of a control process example that may be executed by the gaming machine of an embodiment according to the present invention.

FIG. 15 is a flowchart of a control process example that may be executed by the gaming machine of the embodiment according to the present invention.

FIG. 16 is a flowchart of a control process example that may be executed by the gaming machine of the embodiment according to the present invention.

FIG. 17 is a flowchart of a control process example that may be executed by the gaming machine of the embodiment according to the present invention.

FIG. 18 is a flowchart of a control process example that may be executed by the gaming machine of the embodiment according to the present invention.

FIG. 19 is a diagram illustrating an outline of an arrangement wherein a server and gaming machines are connected via a network.

### DETAILED DESCRIPTION OF THE INVENTION

An embodiment of this invention shall now be described based on the drawings.

[Arrangement of a Gaming Machine]

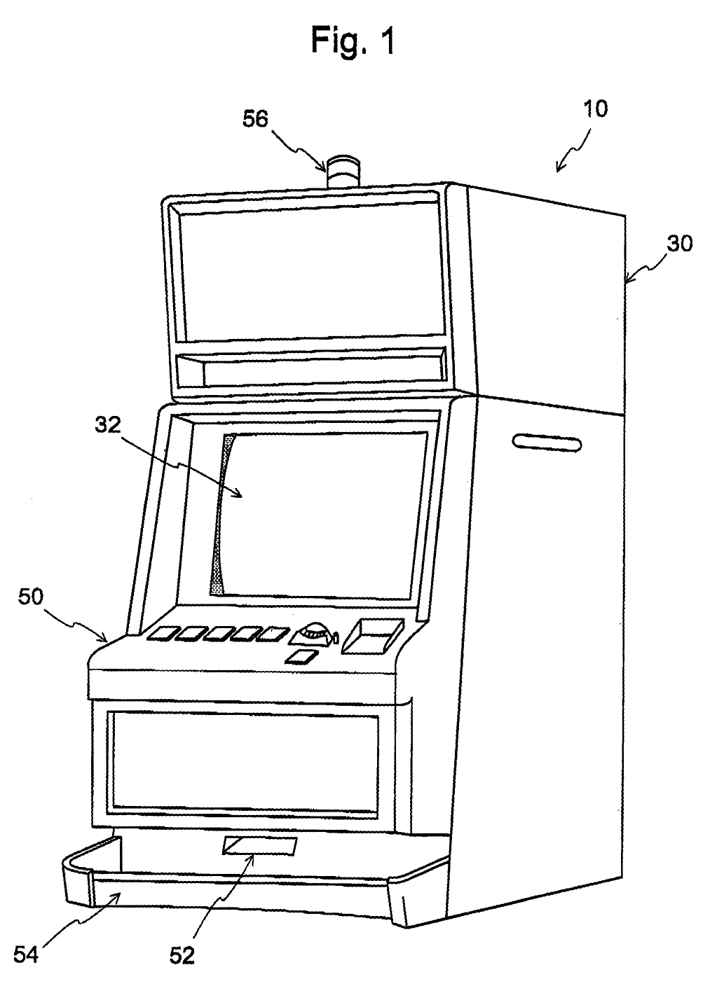

An example of a gaming machine 10, which is an embodiment of this invention, is shown in FIG. 1.

Gaming machine 10 comprises a casing 30, the central front part of casing 30 has an incline somewhat to the rear with respect to the vertical direction, and a display device 32 is disposed on this surface. Display device 32 displays game information when a game is executed and a game progresses on this display device.

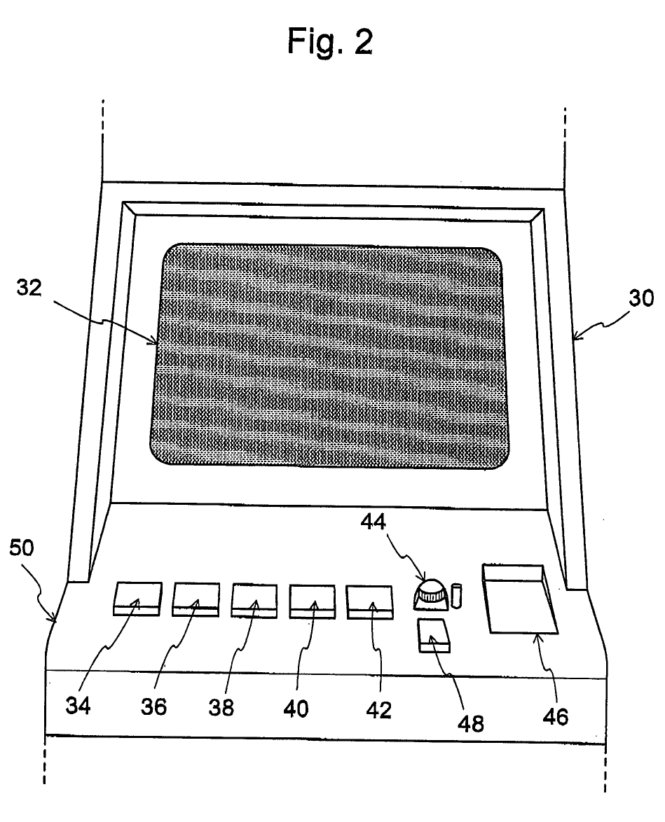

A substantially horizontal base part 50 is disposed below display device 32 and various switches, etc., are disposed on the upper part of this base part. FIG. 2 shows an enlarged view of the vicinity of base part 50.

Five switches are aligned from the left side to the central part of base part 50. These are, from the left side, selection switches 34 and 36, decision switch 38, cancellation switch 40, and bet switch 42. These switches are used to instruct a selection or decision, etc., in the process of executing a game.

A coin slot 44 and a bill slot 46 are disposed at the right side of the upper face of base 50. The execution of a game is enabled by the loading of coins or bills in these slots.

Furthermore, a disbursement switch 48 is disposed near coin slot 44, and by pressing this switch, loaded coins are disbursed from coin disbursement slot 52 at the lower part of the front face of casing 30 and the disbursed coins are accumulated in coin retainer 54.

[Arrangement of the Control Device of the Gaming Machine]

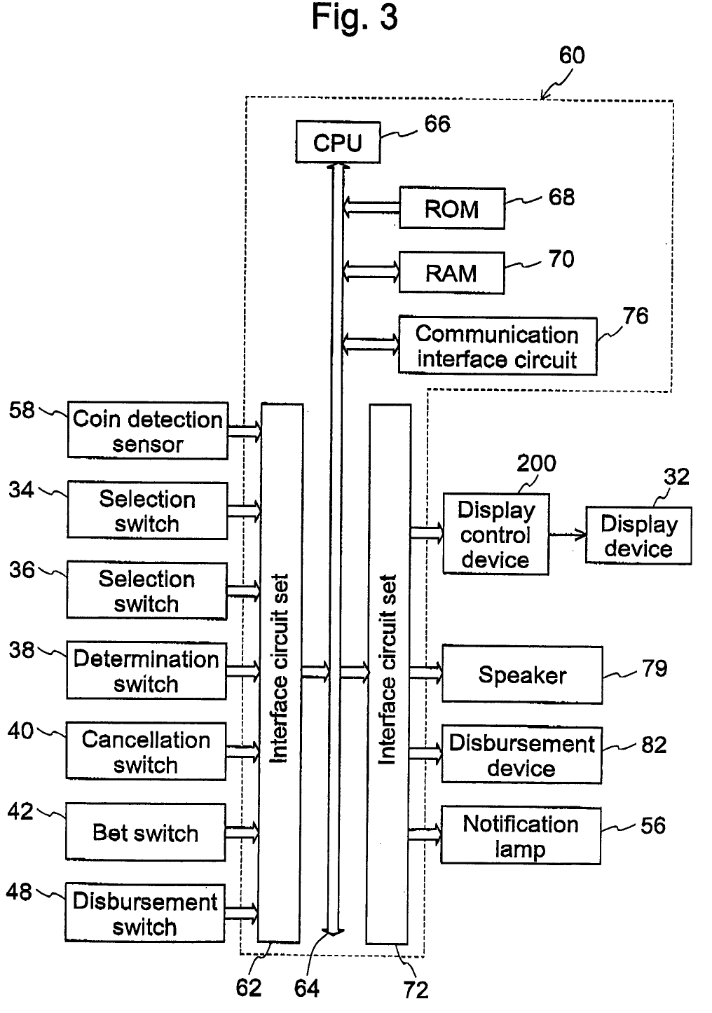

FIG. 3 shows a block diagram of the configuration of a control unit of the above-mentioned gaming machine 10.

The above-mentioned selection switches 34 and 36, decision switch 38, cancellation switch 40, and bet switch 42 are connected to an interface circuit set 62 of a main control circuit 60, and interface circuit set 62 is connected to input/output bus 64. When a switch is pressed, a corresponding predetermined signal is generated and supplied to input/output bus 64. Input/output bus 64 is arranged for input and output of data signals or address signals into and from a CPU 66.

A coin and bill detection sensor 58 is also connected to the above-mentioned interface circuit set 62, and when coins are loaded into the above-mentioned coin slot 44 or bills are loaded into bill slot 46, information concerning the type and number of the loaded coins or bills is converted into a signal and this signal is supplied to interface circuit set 62.

Disbursement switch 48 is also connected to the above-mentioned interface circuit set 62, and when a player presses disbursement switch 48, a predetermined signal is supplied to input/output bus 64, and based on this signal, loaded coins are disbursed to coin disbursement slot 52 by a disbursement device 82 to be described below.

A ROM (read only memory) 68 and a RAM (random access memory) 70 are also connected to the above-mentioned input/output bus 64. ROM 68 stores a control program for controlling the flow of the entire system of the gaming machine. ROM 68 also stores the initial data for executing the control program, a part of a program for performing display control of display device 32, etc. RAM 70 stores the values of flags and variables to be used in the above-mentioned programs and the game program to be described below.

The control programs of this embodiment specifically include a program “using the designs of a deck of playing cards as the above-mentioned symbols and making the symbols be allocated in all of the cells of the above-mentioned matrix,” a program “shifting the symbol, displayed in one of the outer peripheral cells positioned adjacent to the outer periphery of the above-mentioned matrix, along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell,” a program “shifting the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, along the above-mentioned outer peripheral cells to an inner peripheral cell adjacent to the above-mentioned inner peripheral cell, at the same time shifting the symbol displayed in the above-mentioned adjacent inner peripheral cell along the above-mentioned outer peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell,” a program “carrying out a game using the matrix having symbols allocated in all of the above-mentioned cells in the above-mentioned symbol allocating step and, when all cells of a line, made up of cells that indicate a combination of symbols expressing a winning combination in a poker game, become effective, making the magnitude of disbursement of game media or the multiplication factor of disbursement with respect to the quantity of game media betted by the above-mentioned player be determined in accordance with the above-mentioned winning combination,” a program “using the designs of a set of mahjong tiles as the above-mentioned symbols and making the symbols be allocated in all of the cells of the above-mentioned matrix,” and a program “carrying out a game using the matrix having symbols allocated in all of the above-mentioned cells by the above-mentioned positioning and, when all cells of a line, made up of cells that indicate a combination of symbols expressing a predetermined combination, become effective, making the magnitude of disbursement of game media or the multiplication factor of disbursement with respect to the quantity of game media betted by the above-mentioned player be determined in accordance with the above-mentioned combination.”

An interface circuit set 72 is also connected to input/output bus 64. A speaker 81, a notification lamp 56, and disbursement device 82 are connected to interface circuit set 72, and interface circuit set 72 supplies drive signals and drive power for controlling each of these devices in accordance with the results of computations performed by CPU 66.

Notification lamp 56 becomes lit or blinks when an anomaly of gaming machine 10 is detected, when a player calls a game hall worker, etc., and notifies such conditions to a game hall worker.

Furthermore, a communication interface circuit 76 is also connected to input/output bus 64, and communication interface circuit 76 is for communication with a server, etc., via a public telephone line, LAN, or other communication line.

Yet furthermore, a display control device 200 is also connected to interface circuit set 72, and based on a screen display instruction issued from main control circuit 60, display control device 200 generates a drive signal for driving display device 32 connected to display control device 200.

[Internal Lottery Method]

An internal lottery is performed in the gaming machine process to be described below, and with this internal lottery, a random number is generated and internal lottery data is acquired based on the random number obtained.

With regard to the method of generating a random number in the internal lottery, an external random number generation system or a software random number generation system is mainly used. With an external random number generation system, a random number is generated by a random number generating part, such as a binary counter IC, etc., that is disposed on a circuit board separate from the CPU. With a software random number generation system, the CPU itself forms a counter, renews the numerical value of the counter in accordance with a program stored in the ROM, and uses this numerical value as a random number.

With the gaming machine of the present embodiment, a random number is generated by a software random number generation system. However, the method of generating a random number in the gaming machine by this invention is not limited to that by a software random number generation system and an external random number generation system or other arrangement by which a single numerical value can be extracted from a plurality of numerical values without making a player sense regularity may be used instead.

An arrangement wherein a random number is not generated and a symbol is directly selected by a lottery is also possible. Furthermore, the lottery is not limited to that by an electrical process inside a control device, and a symbol may be selected by a physical lottery method instead. For example, balls marked with the symbols used in the corresponding game maybe prepared, placed in a container, taken out one by one, and the symbol marked on the ball that has been taken out may be used as the lottery result.

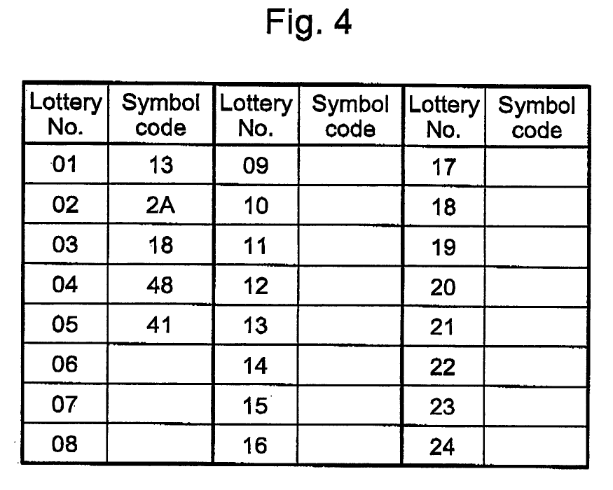

The random number that is obtained by the above-mentioned lottery is converted into a symbol code using a conversion table stored in ROM 68 and stored in the order of selection by a lottery in a data map, such as that shown in FIG. 4. The data map shown in FIG. 4 is an example illustrating the state where a lottery has been performed five times.

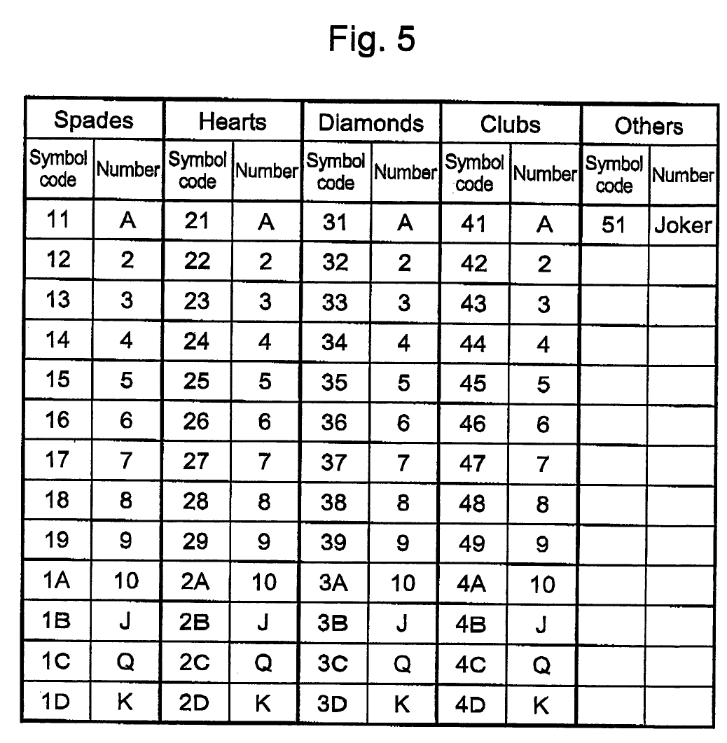

The symbol codes here are codes for identifying each of the playing card designs that are the symbols used in the game by this invention, and are classified as shown in FIG. 5. CPU 66 recognizes the mark of a symbol from the upper digit of the symbol code and the numeral of a symbol from the lower digit of the symbol code and then judges whether or not the combinations along the respective lines form winning combinations.

Similar symbol codes are also used in a case where the designs of mahjong tiles are used as the symbols.

[Configuration of the Display Control Device of the Gaming Machine]

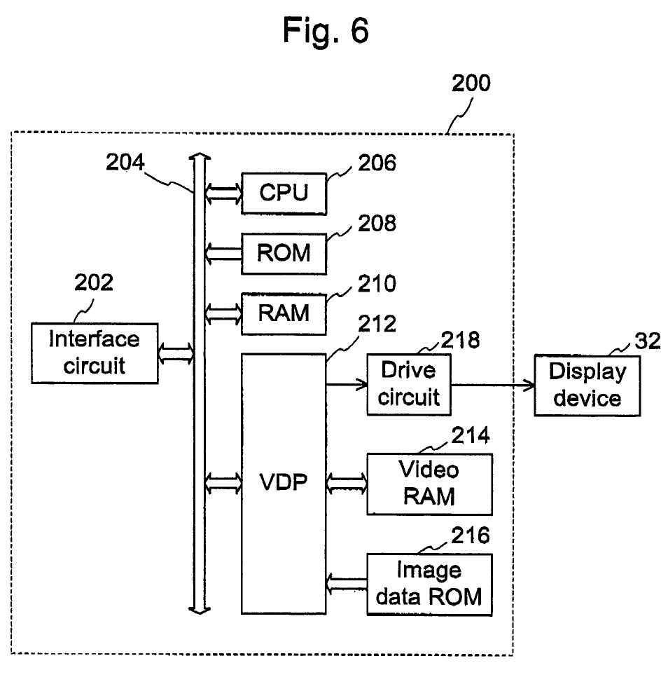

FIG. 6 shows a block diagram of the circuit of the above-mentioned display control device 200.

An interface circuit 202 is connected to an input/output bus 204, and an image display instruction issued from the above-mentioned main control circuit 60 is supplied via interface circuit 202 to input/output bus 204. Input/output bus 204 is arranged for input and output of data signals or address signals to and from CPU 206.

A ROM 208 and a RAM 210 are also connected to the above-mentioned input/output bus 204. ROM 208 stores a display control program for generating drive signals to be supplied to display device 32 based on image display instructions generated from main control circuit 60. Meanwhile, RAM 210 stores the values of the flags and variables used in the above-mentioned program.

Furthermore, an image data processor (referred to hereinafter as “VDP”) 212 is also connected to input/output bus 204. This VDP 212 includes a so-called sprite circuit, a screen circuit, and a palette circuit, and is a processing device that can perform various processes for making display device 32 display images.

To the above-mentioned VDP 212 are connected a video RAM 214, for storing image data in accordance with image display instructions generated from main control circuit 60, and an image data ROM 216, for storing background image data, design image data, and other image data.

By reading and executing the display control program stored in ROM 208, the above-mentioned CPU 206 stores, in video RAM 214, the image data to be displayed on display device 32 in accordance with image display instructions generated from main control circuit 60. The image display instructions generated from main control circuit 60 include a background display instruction, design display instruction, character figure display instruction, and other display instructions.

As mentioned above, image data ROM 216 stores the data of design images, which are identification information images, character figure image data of animated objects and other character figures displayed for an effect screen, background image data, which make up the backgrounds of display devices 32, etc., and other image data.

The respective above-mentioned image data are synthesized at VDP 212, the synthesized image data are thereafter sent to drive circuit 218, and drive circuit 218 drives display device 32 to make images be displayed on image device 32.

[Display Examples of Images]

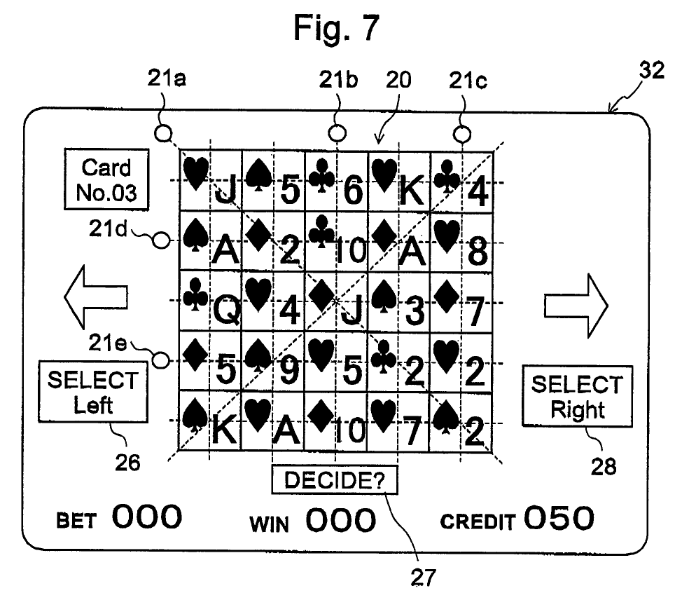

As mentioned above, by recording image data in video RAM 214, images are displayed on display device 32 and a game is thereby made to proceed. Display examples of images that are displayed in this game are shown in FIG. 7 through FIG. 12.

FIG. 7 shows an example of a screen display for making a player select a matrix card at the start of a game. A single matrix card 20 is displayed at the central part of the screen 32 and arrows are displayed to its left and right. These arrows indicate that other matrix cards that the player can select have been prepared, and when a player presses selection switch 34 or 36 in accordance with either arrow and indication 26 or 28, another matrix card is displayed in place of the presently displayed matrix card 20. The player views this card and selects whether to play the game with this card or to play the game using another card. Thus, the player may select the current card as an indication 27 urges. Since it is difficult for a player to quickly recognize in which of the plurality of lines winning combinations are completed, the recognition is facilitated by indicating circles 21a, 21b, 21c, 21d, 21e at the end of the broken lines that express the respective lines in the case of lines in which winning combinations are formed, as shown in FIG. 7. An arrangement is also possible wherein the above-mentioned circles are not indicated in consideration that a player him/herself is to be made to ponder the preparation of winning combinations by shift of cells after selection of a matrix card.

Furthermore, at the lower part of the screen, the number of coins that are betted in the presently played game, the number of coins to be disbursed to the player as a result of a game, and the total number of coins loaded in gaming machine 10 are displayed in that order starting from the left side. With the example of FIG. 7, since the player has not yet bet any coins in the present game, the number of coins betted in the presently played game is indicated as 0. The number of coins to be disbursed as a result of the game is also displayed as being 0. And here, as an example of a case where the player has loaded 50 coins, the total number of coins loaded in this gaming machine 10 is indicated as being 50.

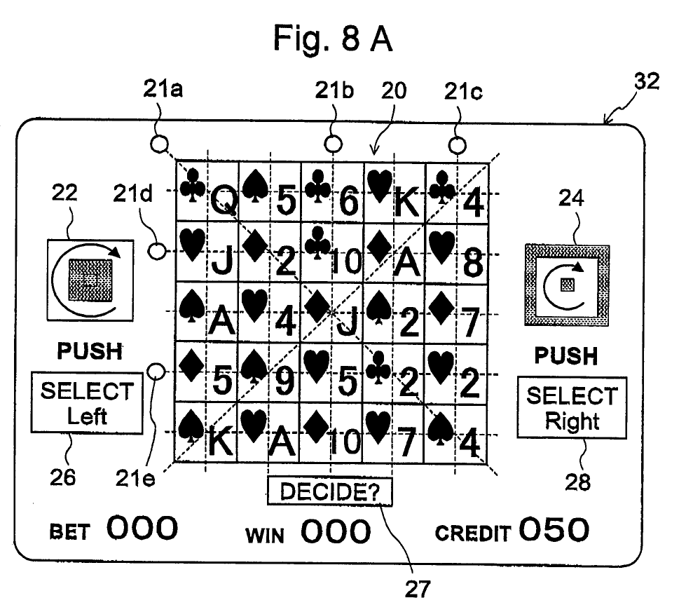

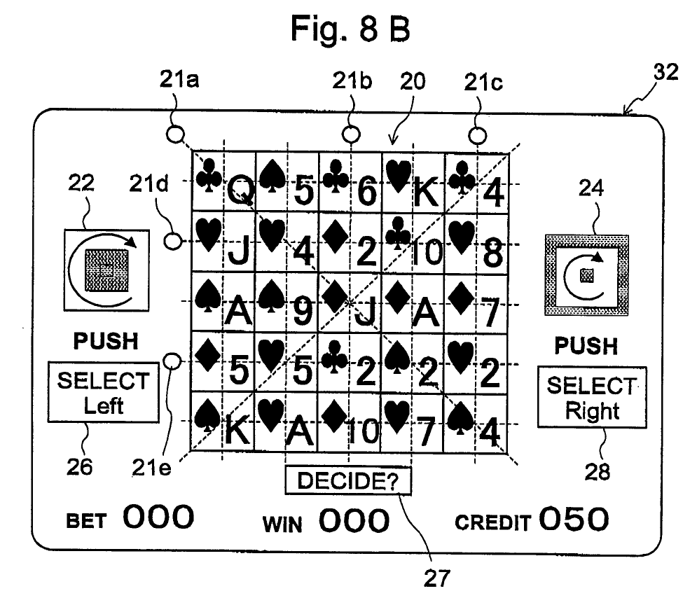

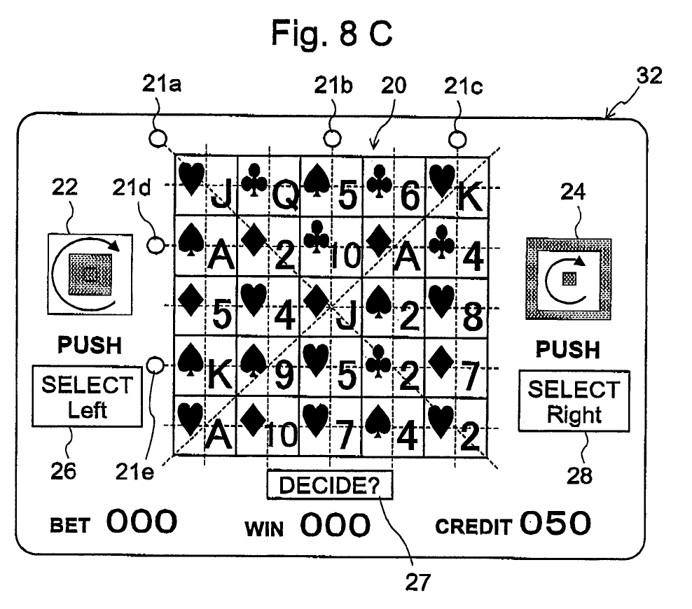

FIGS. 8A-8C show examples of a screen display for letting a player shift cells after a matrix card has been selected. The matrix card 20 that has been selected by the player is displayed at the central part of display device 32, and to the left and right are displayed designs 22, 24 indicating the rotation of cells. FIG. 8A shows the card in the display device before the shift. The design 22 at the left side of the screen indicates the shifting of outer peripheral cells one-by-one in the clockwise direction, and this is executed by pressing selection switch 34 for making the selection at the left. The outer peripheral cells are composed of club-Q, spade-S, club-6, heart-K, club-4, heart-8, diamond-7, heart-2, spade-2, heart-7, diamond-10, heart-A, spade-K, diamond-5, club-Q, and spade-A. The design 24 at the right side of the screen indicates the shifting of inner peripheral cells one-by-one in the clockwise direction, and this is executed by pressing selection switch 36 for making the selection at the right. The lines 21a, 21b, 21c, and 21e show one pair, one pair, one pair, and two pair, respectively. However, the line 21d has no winning combination. This may be made to confuse the player.

FIG. 8B shows the card in the display device 32 after the right shift. Thus, the inner peripheral cells are shifted clockwise so that the lines 21a, 21b, 21c, and 21e show one pair, one pair, one pair, and full house, respectively.

FIG. 8C shows the card in the display device 32 after the left shift. Thus, the outer peripheral cells are shifted clockwise so that the lines 21a, 21b, and 21d show full house, one pair, and on pair, respectively, The lines 21c, 21e have no winning combination.

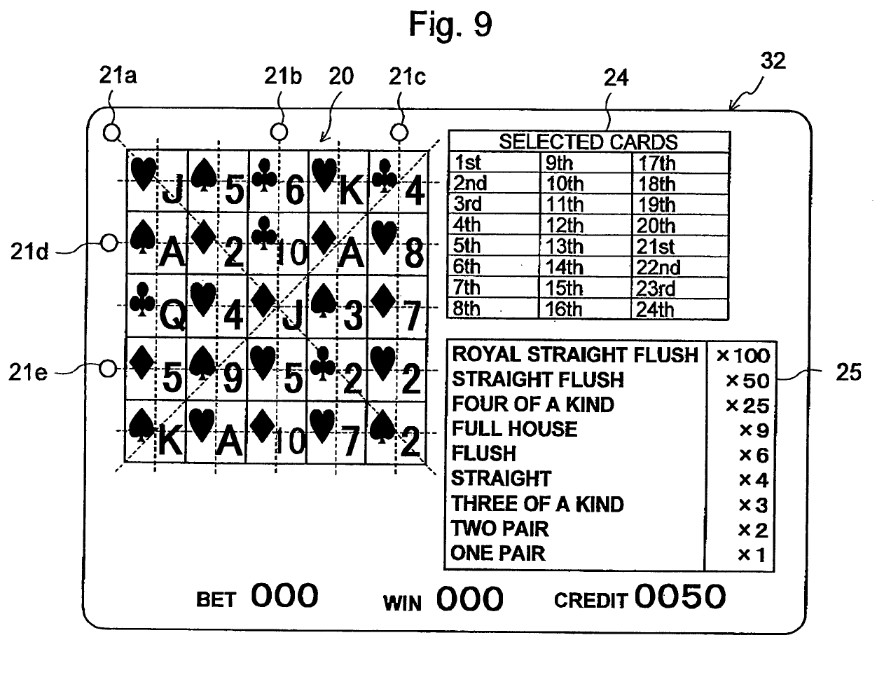

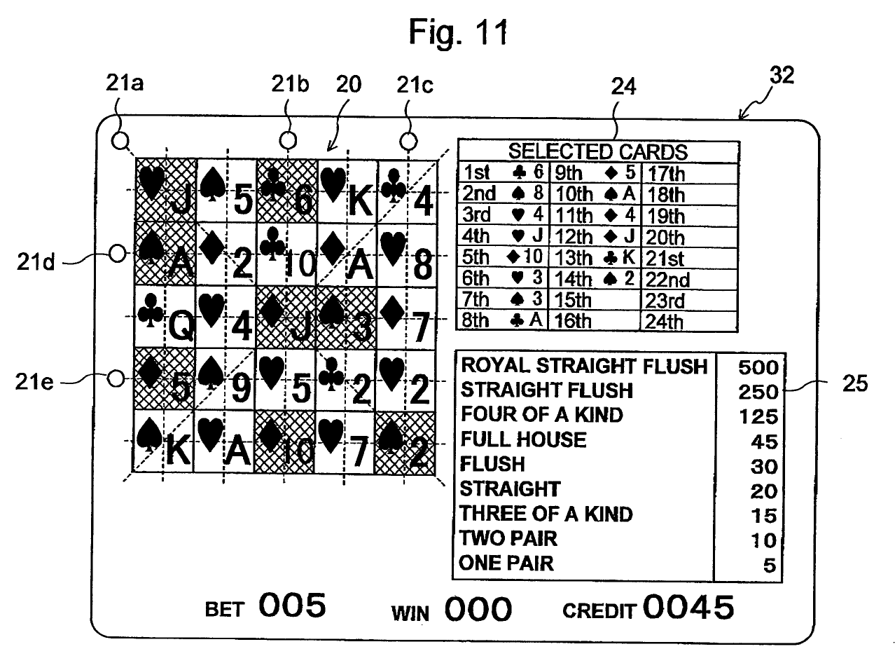

FIG. 9 shows an example of a screen display 32 at a point at which the selection of the matrix card 20 is completed and the player has entered the stage of operation of betting coins. The matrix card 20 that has been selected by the player is shown at the left side of the screen and at the upper right part of the screen, a list 24, which indicates, in the order of the lottery, the card designs that have been selected after the start of the game, is displayed (see FIG. 11). Furthermore, at the lower right part of the screen is displayed a multiplication factor table 25, which indicates the disbursement multiplication factors with respect to the number of coins betted that are used when coins are to be disbursed for cases of completion of lines of various winning combinations. The player determines the number of betted coins upon referencing the matrix card and the multiplication factor table.

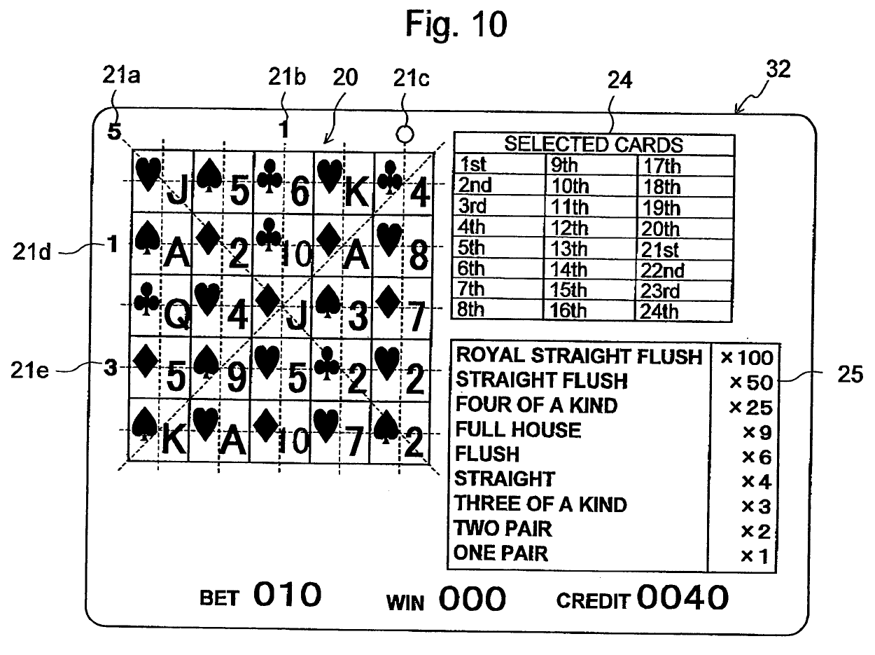

FIG. 10 shows a screen display example for a game of a method, with which a player does not bet coins for the entirety of a matrix card 20 but bets coins according to each line 21a, 21b, 21d, or 21e, and illustrates the screen at a point in time at which coins have been betted according to line. With a line on which coins are betted, the number of betted coins is displayed in place of each circle 21a, 21b, 21d, or 21e indicating the forming of a winning combination, and the total number of coins betted is shown at the lower left part of the screen.

FIG. 11 shows a screen display example in the middle of the progress of the game. With this game, the player has betted five coins and this number is displayed at the lower left part of the screen. Also, fourteen cards have already been selected and the designs of the respective cards are displayed in the order of selection in the list 24 at the upper right part of the screen. Of the designs displayed in the matrix card 20, the designs that match the designs of the cards that have been selected are indicated by changing the color of the cells in which the designs a redisplayed, thereby making the player recognize that these cells have been made effective.

In the multiplication factor table 25 displayed at the lower left part of the screen, the numbers of coins that may actually be disbursed are determined and displayed by multiplying the numerals of the multiplication factors shown in FIG. 9 by the actually betted number of coins.

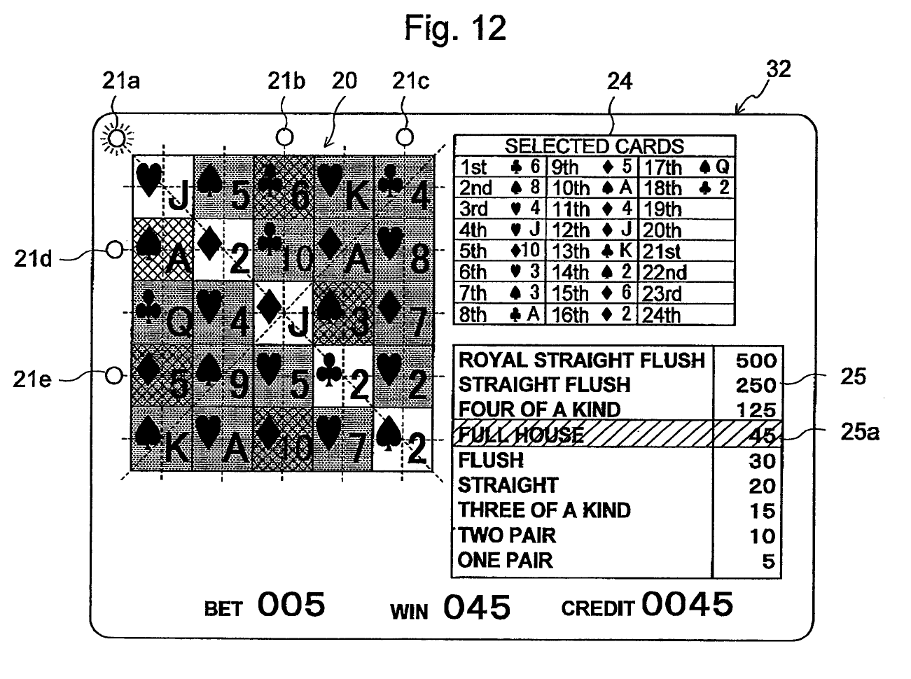

FIG. 12 shows a screen display example of a case where all cells along the diagonal line that extends from the upper left cell to the lower right cell of the matrix card have become effective and the “full house” winning combination has been formed. In this case, by making the colors of the cells along this line 21a different from those of other cells, the cells of the line 21a are made more readily identifiable and the player is thereby made to recognize that this line has been completed. The “full house” part 25a of the multiplication factor table 25 at the lower right part of the screen is also differed in color to notify the winning combination that has been completed and the number of coins to be disbursed to the player. The number of coins to be disbursed in this game is also displayed at the lower central part of the screen. This number is thereafter added to the remaining number of coins loaded that is indicated to the right.

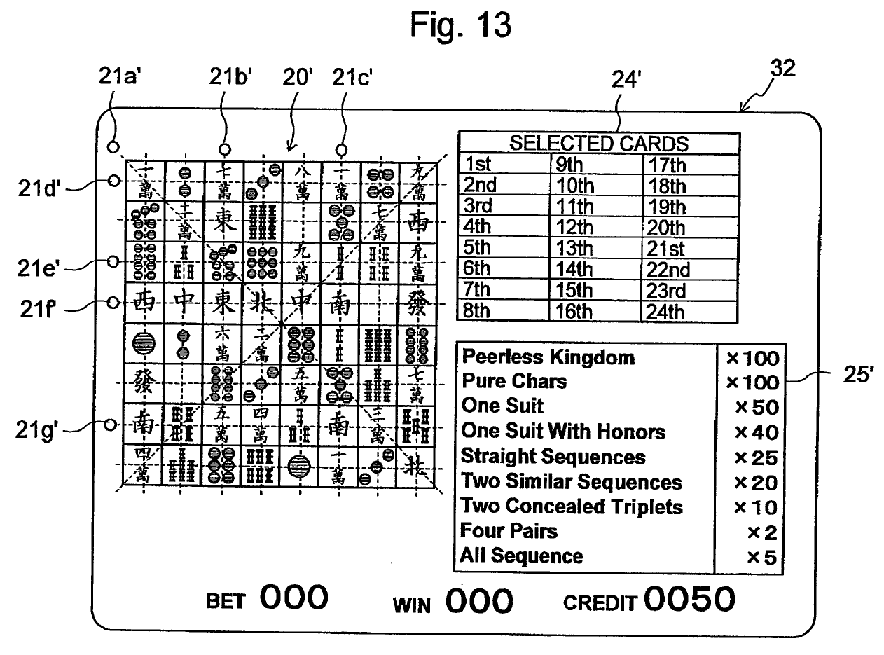

FIG. 13 shows an example of screen display 32 for a case where the designs of mahjong tiles are used as the symbols. Though normally in mahjong, one winning combination is formed by fourteen mahjong tiles, with this game machine of an embodiment according to the present invention, the aligning of fourteen cells along a single line will cause the game time to become long, the screen display to become fine, and the game to become a complex one for which the ascertainment of circumstances will be difficult for a player, and due to these reasons, the interest in a game may decrease. Thus by employing an arrangement, with which a six-row×six-column matrix card is used and a winning combination is formed by two combinations of three symbols each or employing an arrangement, with which an eight-row×eight-column matrix card is used and a winning combination is formed by two combinations of three symbols each and one combination of two symbols, etc., and thus employing an arrangement with which winning combinations similar to winning combinations of mahjong are formed, a game can be carried out without loss of interest by the players. FIG. 13 shows a display example of a case where an eight-row×eight-column matrix card is used.

In a case where an eight-row×eight-column matrix card 20, such as shown in FIG. 13, is used, four rows×four columns of cells further exist at the inner side of the inner peripheral cells. Arrangements may be made to enable shift of these cells as well or these cells may be arranged so as not to be shifted in order to avoid the game method from becoming complex.

Also, cards to be selected will be listed with designs of the respective tiles in the order of selection in the list 24′ at the upper right part of the screen. In the multiplication factor table 25′ displayed at the lower left part of the screen, the numbers of coins that may actually be disbursed are determined and displayed by multiplying the numerals of the multiplication factors by the actually betted number of coins. Lines 21a′-21g′ indicate existence of winning combinations.

[Operation of the Gaming Machine]

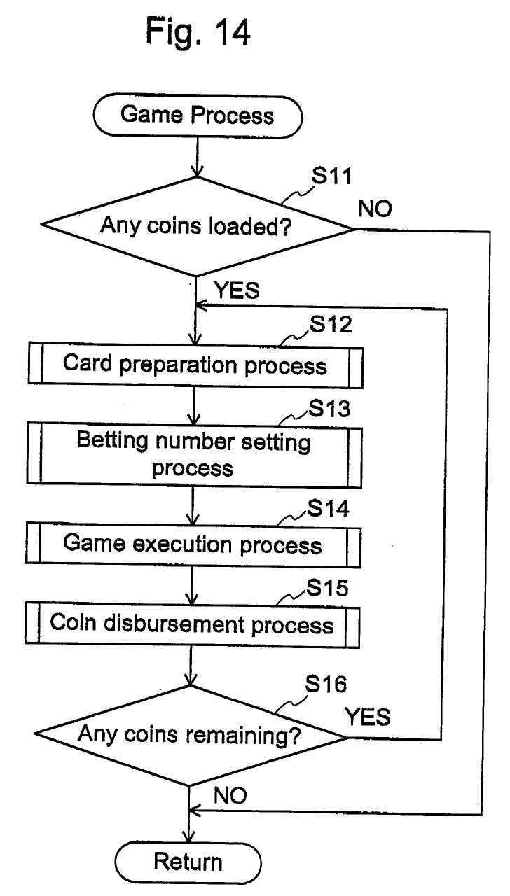

Subroutines for controlling gaming machine 10, which are executed by the above-described main control circuit 60, are shown in FIG. 14 through FIG. 18. The subroutine shown in FIG. 14 is called and executed at a predetermined timing from a main program of gaming machine 10 that is executed in advance.

In the following, it shall be deemed that gaming machine 10 has been started in advance, the variables used in the above-described CPU 66 are initialized, and steady-state operation is being carried out.

Though with the embodiment described below, a case where the designs of the cards of a card game are used as the symbols and a matrix card of five rows×five columns is used shall be described as an example, control by the same subroutines is performed even in a case where the designs of mahjong tiles are used as the symbols and a matrix card of a different size is used.

FIG. 14 shows a subroutine for controlling the overall progress of the game.

First, in the process of step S11, whether or not coins or bills have been loaded into the gaming machine is judged. In this process, CPU 66 judges whether or not a signal indicating that the loading of coins or bills has been received from coin and bill detection sensor 58. If CPU 66 judges that this signal has not been received, that is, if it is judged that the player has not loaded coins or bills, the present subroutine is ended immediately without performing any processes, while if it is judged that the above-mentioned signal has been received, that is, if it is judged that the player has loaded coins or bills, a transfer to step S12 is performed.

Next, in the process of step S12, the preparation of a matrix card is performed. In this process, CPU 66 prepares a predetermined number of matrix cards, in each of which the designs of playing cards are aligned in accordance with a lottery. This process shall be described further below. When this process is ended, a transfer to step S13 is performed.

Next, in the process of step S13, the setting of the betting quantity is performed. In this process, CPU 66 urges the player to input the desired betting quantity and the betting quantity for the game is set based on the information input by the player. This process shall be described further below. When this process is ended, a transfer to step S14 is performed.

Next, in the process of step S14, the game is executed. In this process, CPU 66 performs a lottery selection of symbols comprising playing card designs one by one and the game progresses accordingly. This lottery is repeated a predetermined number of times and the game ends at the point at which the lottery of the predetermined number of times is ended. These processes shall be described further below. When this process is ended, a transfer to step S15 is performed.

Next, in the process of step S15, the payment of coins is performed. In this process, CPU 66 performs the payment of coins based on the result of the game that was executed in step S14. This process shall be described further below. When this process is ended, a transfer to step S16 is performed.

Next, in the process of step S16, whether or not there are remaining coins is judged. In this process, CPU 66 judges whether or not there remain any coins loaded into gaming machine 10 by the player or coins won by the player. If CPU 66 judges that there still remain coins loaded into gaming machine 10 by the player or coins won by the player, since the playing of a new game will then be possible, a return to step S12 is performed, and if it is judged that there no longer remain any coins loaded into gaming machine 10 by the player or coins won by the player, since the game can no longer be continued in this case, the present subroutine is ended immediately.

[Card Preparation Process]

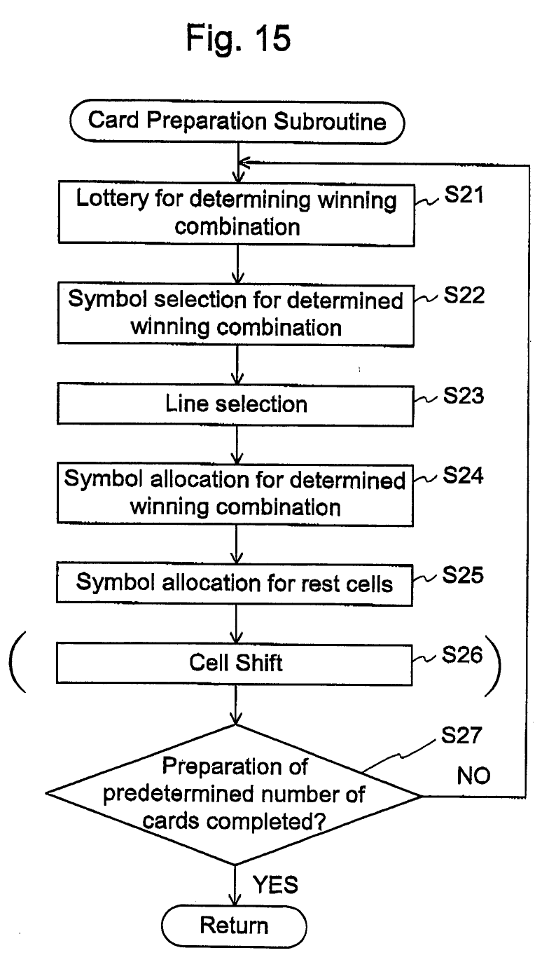

In the above-described step S12, a subroutine such as that shown in FIG. 15 is called.

First in the process of step S21, a lottery selection of a winning combination, in a case where at least one or more of winning combinations will be formed in a matrix card necessarily, is performed. In this process, CPU 66 selects, by a lottery, one winning combination from among a determined winning combination list stored in a predetermined location of ROM 68. When this process is ended, a transfer to step S22 is performed.

Next, in the process of S22, the selection of symbols used in the determined winning combination is performed. In this process, CPU 66 performs selection of the symbols used in the determined winning combination that was determined in the above-described step S21. CPU 66 selects the five symbols necessary for arranging this winning combination.

For example, if the determined winning combination is a “royal straight flush,” one mark is selected by a lottery from among the four marks of spades, hearts, diamonds, and clubs. Since in the case of this winning combination, the numbers will necessarily be the five numbers of A, K, Q, J, and 10, only the lottery selection of the mark is necessary.

In a case where the determined winning combination is a “full house,” first, one symbol is selected and then two symbols, which are the same in number as the first symbol selected but differ in marks, are selected. Next, a symbol of a number that differs from that of the first symbol is selected and then one symbol that is of the same number but of different mark is then selected. A combination made up of a set of three symbols of the same number and a set of two symbols of the same number that differs from that of the prior set is thus formed.

When the above process is ended, a transfer to step S23 is performed.

Next, in the process of step S23, the line along which the determined winning combination is to be aligned is selected. CPU 66 determines the position of the line along which the combination of symbols, determined in step S22 described above, is to be aligned. CPU 66 performs a lottery selection of which line among the twelve lines of the matrix card the symbols that make up the determined winning combination are to be aligned along and thereby determines a single line. When this process is ended, a transfer to step S24 is performed.

Next, in the process of step S24, the allocating of the symbols that make up the determined winning combination is performed. In this process, CPU 66 aligns the five symbols determined in the above-described step S22 along the line determined in the above-described step S23. CPU 66 determines, by lotteries, to which cells the five symbols should be allocated along the line, respectively. Thus, each cell along the line has each symbol accordingly. After the process is completed, it proceeds to step S25.

Next, in the process of step S25, the allocation of symbols in the remaining cells is performed. In this process, CPU 66 allocates symbols to the rest twenty cells where symbols were not allocated in the above-described step S24. For each of these twenty cells, CPU 66 determines, by lotteries, which symbol to be allocated, allocates the selected symbol to each of these cells, and thus allocates symbols to all twenty five cells of the matrix card. When this process is completed, it proceeds to step S26.

Next in the process of step S26, the shift of cells is performed. In this process, CPU 66 causes shifts of the outer peripheral cells and inner peripheral cells respectively so that the symbols that make the determined winning combination positioned in the above-described steps S21 to S24 will not be aligned along one line. When this process is completed, it proceeds to step S27. However, the cell shift process S26 is an option such that the card preparation subroutine may not have the process S26. In the case, the cell shift process s26 may be skipped after symbol allocation process s25 such that it proceeds to S27 directly.

Next, in the process of step S27, whether or not the preparation of the predetermined number of matrix cards has been completed is judged. In this process, CPU 66 judges whether or not the number of matrix cards prepared by the above-described processes of step S21 to step S25 has become equal to the predetermined number of cards. If CPU 66 judges that the predetermined number of matrix cards have not been prepared, a return to step S21 is performed in order to prepare the remaining cards while if it is judged that the predetermined number of matrix cards have been prepared, this subroutine is ended immediately.

By carrying out the above-described processes of the present subroutine, a plurality of matrix cards are prepared, and since the carrying out of the above-described processes of steps S21 to S26 enables “alignment of the above-mentioned symbols so that, depending on the results of shift of the above-mentioned outer peripheral cells and the above-mentioned inner peripheral cells by the above-mentioned outer peripheral cell shift means and inner peripheral cell shift means, a combination of symbols that enables the provision of benefit to an above-mentioned player in the form of a quantity of game media disbursed or a multiplication factor of disbursement with respect to the quantity of game media betted by the above-mentioned player of a predetermined standard or more, will be aligned in at least one or more of the above-mentioned plurality of lines,” a matrix, with which a winning combination cannot be formed at all by any alignment of symbols, will not be presented to a player, and the player can thus anticipate the receiving of benefit depending on the shift of cells no matter which card he/she selects.

Also, though the present embodiment has an arrangement wherein symbols are allocated in advance so that a winning combination that can be formed by certain shifts of cells is contained in a matrix, this invention is not limited thereto, and the symbols may be allocated in all cells by lotteries. In this case, the processes of the above-described steps S21 to S24 and step S26 are not performed.

[Betting Number Setting Process]

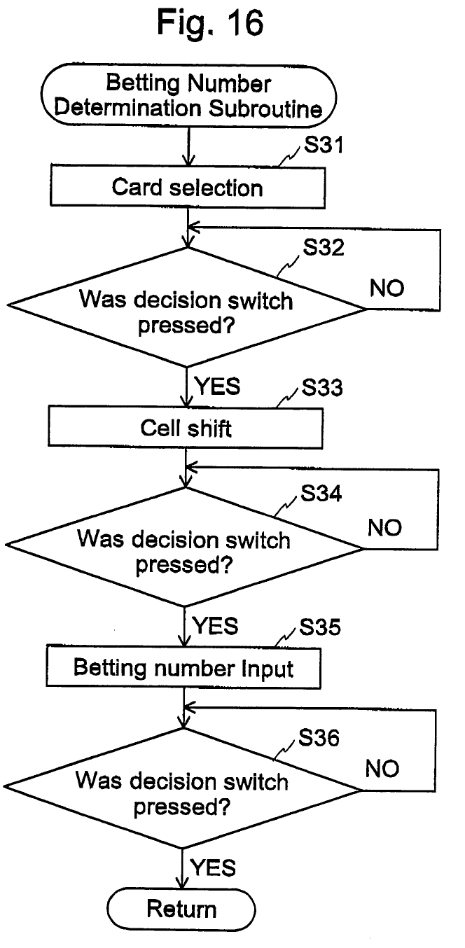

In the above-described step S13, a subroutine such as that shown in FIG. 16 is called.

First in the process of step S31, the card selection screen is displayed. In this process, CPU 66 makes the card selection screen be displayed on display device 32 and makes the player select one card from among the plurality of cards prepared in step S12. Here, one of the plurality of cards is displayed on display device 32, and with regard to the remaining cards, one card among the other cards is displayed upon being interchanged with the already displayed card when the player presses a selection switch. By repeating this operation, all of the cards prepared in step S12 can be displayed to the player. When this process is ended, a transfer to step S32 is performed.

Next, in the process of step S32, whether or not the decision switch has been pressed is judged. In this process, CPU 66 judges whether or not the player has pressed the decision switch. If CPU 66 has not received a signal indicating that the decision switch has been pressed from the switch, it judges that the player has not yet pressed the decision switch and this step is repeated, and if the signal indicating that the decision switch has been pressed is received from the switch, it is judged that the player has pressed the decision switch and a transfer to step S33 is performed.

Next, in the process of step S33, a cell shift screen is displayed. In this process, CPU 66 makes display device 32 display the card selected in steps S31 and S32 and a screen that urges the player to perform cell shift. When this process is ended, a transfer to step S34 is performed.

Next, in the process of step S34, whether or not the decision switch has been pressed is judged. In this process, CPU 66 judges whether or not the player has pressed the decision switch. If CPU 66 has not received a signal indicating that the decision switch has been pressed from the switch, it judges that the player has not yet pressed the decision switch and this step is repeated, and if the signal indicating that the decision switch has been pressed is received from the switch, it is judged that the player has pressed the decision switch and a transfer to step S35 is performed.

Next, in the process of step S35, a betting quantity input screen is displayed. In this process, CPU 66 displays the card, for which cell shift was performed in the above-described steps S33 and S34, on display device 32 and displays a screen that urges the player to determine the number of coins to be betted on this card. At this point, in addition to the card, a table, which indicates, for the number of coins betted, the multiplication factors of coins that are returned in accordance with the types of completed winning combinations, is also displayed, and the player determines the number of coins betted by referencing this table. When this process is ended, a transfer to step S36 is performed.

Next, in the process of step S36, whether or not the decision switch has been pressed is judged. In this process, CPU 66 judges whether or not the player has pressed the decision switch after inputting the desired number of coins betted. If CPU 66 has not received a signal indicating that the decision switch has been pressed from the switch, it judges that the player has not yet pressed the decision switch and this step is repeated, and if the signal indicating that the decision switch has been pressed is received from the switch, it is judged that the player has pressed the decision switch and this subroutine is ended immediately.

Since by performing the above-described processes of steps S33 and S34, “shifting the symbol, displayed in one of the outer peripheral cells positioned adjacent to the outer periphery of the above-mentioned matrix, along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell” and “shifting the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, along the above-mentioned outer peripheral cells to an inner peripheral cell adjacent to the above-mentioned inner peripheral cell, at the same time shifting the symbol displayed in the above-mentioned adjacent inner peripheral cell along the above-mentioned outer peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell” are enabled, the fun of a “bingo game” of anticipating whether or not a line of effective cells will be completed can be combined with the fun of a “poker game” or a “mahjong game” of changing the combinations of symbols displayed in effective cells to complete a winning combination along a line and change the quantity of game media disbursed upon completion of this line and the fun of a “puzzle game” of pondering how to shift the cells to form a winning combination by which a game media disbursement of high multiplication factor can be obtained, thereby enabling a new way of enjoying a game in which the aim is not just to complete any line among the plurality of lines in a given card in a “bingo game” but in which a winning combination can be completed by rearranging, according to rules, the symbols displayed on the card and the multiplication factor of disbursement with respect to the quantity of game media disbursed varies according to the winning combination of a completed line.

[Game Execution Process]

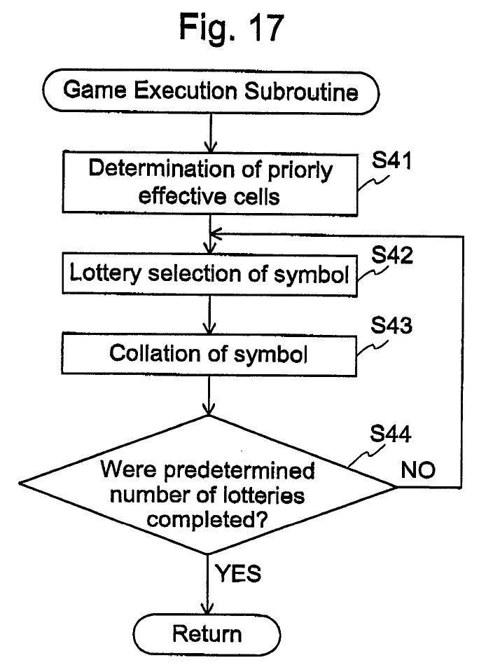

In the above-described step S14, a subroutine such as that shown in FIG. 17 is called.

First in the process of step S41, the determination of priorly effective cells is performed. In this process, CPU 66 performs a lottery for determining cells, among the twenty five cells of the matrix card, that are to be effective from the start of the game. CPU 66 performs a lottery regarding the number and positions of the cells to be made effective, and based on this result, makes effective the cells that are to be made effective. When this process is ended, a transfer to step S42 is performed.

Next, in the process of step S42, a lottery selection of a symbol is performed. In this process, CPU 66 selects one symbol by an internal lottery. The selected symbol is then displayed in the list of lottery results displayed at the upper right part of display device 32. If the selected symbol has already been selected once in the same game and is displayed in the above-mentioned list, the lottery result is not displayed and the lottery is performed again so that a new symbol will be selected again. When the above processes are ended, a transfer to step S43 is performed.

Next, in the process of step S43, collation of the symbol is performed. In this process, CPU 66 collates the symbol selected in the above-described step S42 with the symbols displayed in the matrix card that is displayed on display device 32. If the same symbol as the selected symbol is displayed in the matrix card, the cell in which the symbol is displayed is made effective and the color of this cell is changed. When the above process is ended, a transfer to step S44 is performed.

Next, in the process of step S44, whether or not the lottery has been performed the predetermined number of times is judged. In this process, CPU 66 judges whether or not the lottery selection of a symbol, executed in the above-described step S42, has been executed the predetermined number of times. If CPU 66 judges that the number of times this lottery has been performed has not yet reached the predetermined number times, a return to step S42 is performed, and if it is judged that the number of times this lottery has been performed has reached the predetermined number times, this subroutine is ended immediately.

Though with the present embodiment, even if the completion of a winning line among the plurality of lines is achieved prior to the number of lotteries reaching the predetermined number, the lottery is repeated until the number of lotteries reaches the predetermined number of times, this invention is not limited thereto, and arrangements may be made so that if the completion of a winning line among the plurality of lines is achieved prior to the number of lotteries reaching the predetermined number of times, the lottery is ended at that point. In this case, the judgment criterion of the process of step S44 will be: “end of the predetermined number of lotteries or completion of a winning line.”

[Coin Disbursement Process]

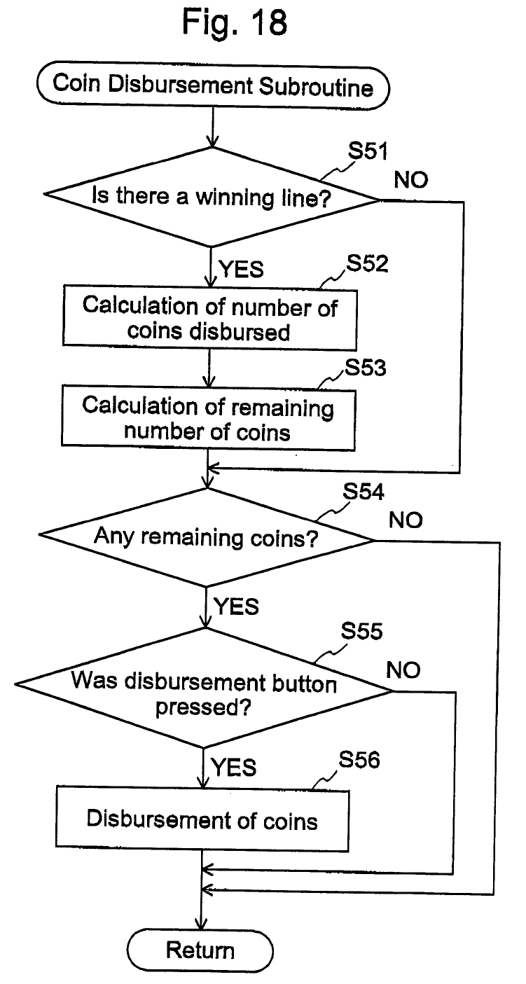

In the above-described step S15, a subroutine such as that shown in FIG. 18 is called.

First, in the process of step S51, whether or not there is a winning line among the plurality of lines in the matrix card is judged. In this process, CPU 66 judges whether or not a line, with which all cells have been made effective and with which a winning combination is formed, exists among the combinations of symbols along the plurality of lines in the matrix card displayed on display device 32. If CPU 66 judges that there are no winning lines among the plurality of lines, a transfer to step S54 is performed while if it is judged that there is a winning line among the plurality of lines, a transfer to step S52 is performed.

Next, in the process of step S52, the number of coins disbursed is calculated. In this process, CPU 66 calculates the number of coins disbursed by multiplying the number of coins betted by the player in the game by the disbursement multiplication factor that is in accordance with the type of winning combination of the line that has been judged to be a winning line in the above-described step S51. Here, if a plurality of winning lines exist, the multiplication factor of the winning combination having the highest disbursement multiplication factor among the respective winning combinations is applied. When the above process is ended, a transfer to step S53 is performed.

Though with the present embodiment, if a plurality of winning lines exist, the multiplication factor of the winning combination having the highest disbursement multiplication factor among the respective winning combinations is applied, this invention is not limited thereto, and arrangements may be made to add the disbursement multiplication factors of all winning combinations and multiply this by the number of coins betted by the player.

Next, in the process of step S53, the summing of the remaining number of coins owned by the player is performed. In this process, CPU 66 adds the number of coins disbursed, which was calculated in the above-described step S52, to the number of coins that the player has loaded in gaming machine 10 but remains without being betted on the game, When this process is ended, a transfer to step S54 is performed.

Next, in the process of step S54, whether or not there are any remaining coins is judged. In this process, CPU 66 judges whether or not any coins reserved in gaming machine 10 remain as a result of the player loading into gaming machine 10 or receiving disbursement by winning in the game. If CPU 66 judges that there are no remaining coins, since the game can then no longer be continued in this case, the present subroutine is ended immediately without performing any other processes, while if it is judged that there are remaining coins, a transfer to step S55 is performed.

Next, in the process of step S55, whether or not the disbursement switch has been pressed is judged. In this process, CPU 66 judges whether or not the player has pressed disbursement switch 48. If CPU 66 has not received a signal indicating that disbursement switch 48 has been pressed from the switch, it judges that the player has not pressed disbursement switch 48 and the present subroutine is ended immediately without performing any other processes, and if the signal indicating that disbursement switch 48 has been pressed is received from the switch, it is judged that the player has pressed disbursement switch 48 and a transfer to step S56 is performed.

Next, in the process of step S56, a coin disbursement process is performed. In this process, CPU 66 sends a signal, for disbursing the total number of coins reserved in the gaming machine 10, that is, the sum of the number of coins that the player loaded into gaming machine 10 but has not been betted on the game and the number of coins won by the player in the game, to disbursement device 82, and upon receiving this signal, disbursement device 82 discharges the total number of coins from coin disbursement slot 52. When the above processes are ended, this subroutine is ended immediately.

By carrying out the respective control processes above, it becomes possible with a gaming machine, such as a so-called “bingo gaming machine,” in which cells of a matrix allocated to a player are made effective in accordance with a lottery, to combine the fun of a “bingo game” of anticipating whether or not a line of effective cells will be completed with the fun of a “poker game” or a “mahjong game” of changing the combinations of symbols displayed in effective cells to complete a winning combination along a line and change the quantity of game media disbursed upon completion of this line and the fun of a “puzzle game” of pondering how to shift the cells to form a winning combination by which a game media disbursement of high multiplication factor can be obtained, thereby enabling a new way of enjoying a game in which the aim is not just to complete any line among the plurality of lines in a given card in a “bingo game” but in which a winning combination can be completed by rearranging, according to rules, the symbols displayed on the card and the multiplication factor of disbursement with respect to the quantity of game media disbursed varies according to the winning combination of a completed line.

[Arrangement of a Server]

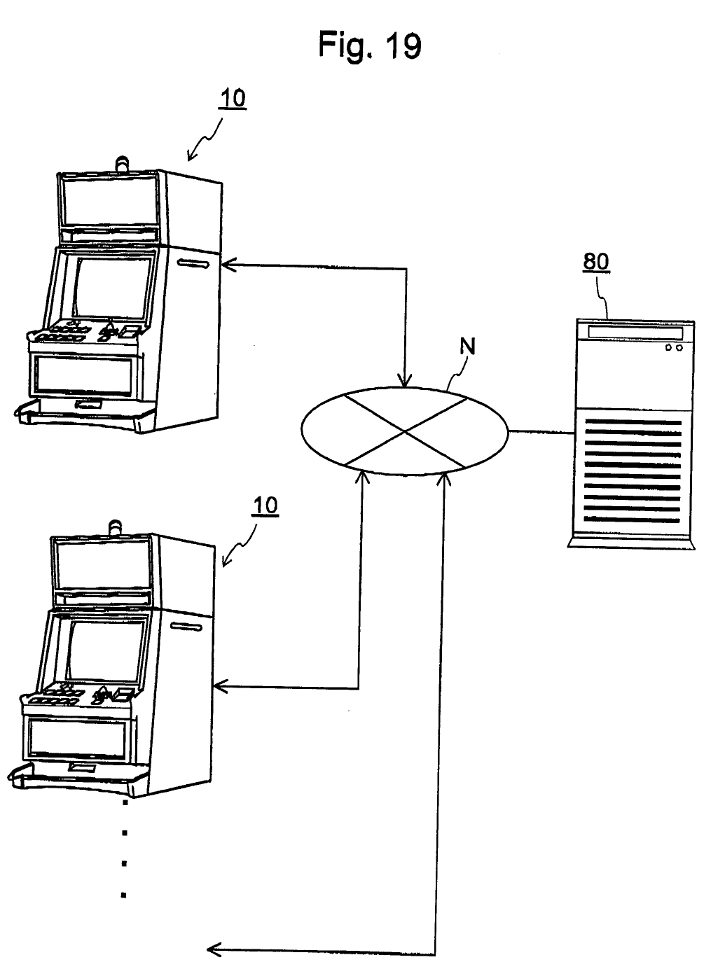

Though the above-described embodiment was arranged with just a gaming machine 10, gaming machines 10 may be connected to a server 80 and be enabled to perform the sending and receiving of a predetermined information with server 80 as shown in FIG. 19. Specifically, server 80 performs an internal lottery process such as that described above and supplies the internal lottery data to gaming machines 10, which are terminal devices, and each gaming machine 10 may be made to display, upon receiving the internal lottery data, images based on the internal lottery data. Needless to say, server 80 may be arranged to select images to be displayed based on the internal lottery data and supply the image data to gaming machines 10, and each gaming machine 10 may be made to display, upon receiving the image data, images based on the image data,

That is server 80 controls gaming machines 10 and has the following functions.

(A) A function of “using the designs of a deck of playing cards as the above-mentioned symbols and making the symbols be allocated in all of the cells of the above-mentioned matrix.”

(B) A function of “shifting the symbol, displayed in one of the outer peripheral cells positioned adjacent to the outer periphery of the above-mentioned matrix, along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell.”

(C) A function of “shifting the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, along the above-mentioned outer peripheral cells to an inner peripheral cell adjacent to the above-mentioned inner peripheral cell, at the same time shifting the symbol displayed in the above-mentioned adjacent inner peripheral cell along the above-mentioned outer peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell.”

(B) A function of “carrying out a game using the matrix having symbols allocated in all of the above-mentioned cells by the above-mentioned symbol allocation means and, when all cells of a line, made up of cells that indicate a combination of symbols expressing a winning combination in a poker game, become effective, determining, in accordance with the above-mentioned winning combination, the magnitude of disbursement of game media or the multiplication factor of disbursement with respect to the quantity of game media betted by the above-mentioned player.”

(E) A function of “using the designs of a set of mahjong tiles as the above-mentioned symbols and making the symbols be allocated in all of the cells of the above-mentioned matrix.”

(F) A function of “carrying out a game using the matrix having symbols allocated in all of the above-mentioned cells by the above-mentioned allocation means and, when all cells of a line, made up of cells that indicate a combination of symbols expressing a predetermined combination, become effective, making the magnitude of disbursement of game media or the multiplication factor of disbursement with respect to the quantity of game media betted by the above-mentioned player be determined in accordance with the above-mentioned combination.”

By arranging server 80 to control gaming machines 10 in the above-described manner, it becomes possible with gaming machines, such as a so-called “bingo gaming machine,” in which cells of a matrix allocated to a player are made effective in accordance with a lottery, to combine the fun of a “bingo game” of anticipating whether or not a line of effective cells will be completed with the fun of a “poker game” or a “mahjong game” of changing the combinations of symbols displayed in effective cells to complete a winning combination along a line and change the quantity of game media disbursed upon completion of this line and the fun of a “puzzle game” of pondering how to shift the cells to form a winning combination by which a game media disbursement of high multiplication factor can be obtained, thereby enabling a new way of enjoying a game in which the aim is not just to complete any line among the plurality of lines in a given card in a “bingo game” but in which a winning combination can be completed by rearranging, according to rules, the symbols displayed on the card and the multiplication factor of disbursement with respect to the quantity of game media disbursed varies according to the winning combination of a completed line.

Also, as the terminal devices connected to server 80, personal computers and portable telephones and other portable terminals may be used, and by making server 80 send image data for display, data indicating such image data, audio data, etc., to terminal devices, the fun of a “bingo game” of anticipating whether or not a line of effective cells will be completed can be combined with the fun of a “poker game” or a “mahjong game” of changing the combinations of symbols displayed in effective cells to complete a winning combination along a line and change the quantity of game media disbursed upon completion of this line and the fun of a “puzzle game” of pondering how to shift the cells to form a winning combination by which a game media disbursement of high multiplication factor can be obtained, thereby enabling a new way of enjoying a game in which the aim is not just to complete any line among the plurality of lines in a given card in a “bingo game” but in which a winning combination can be completed by rearranging, according to rules, the symbols displayed on the card and the multiplication factor of disbursement with respect to the quantity of game media disbursed varies according to the winning combination of a completed line.

Furthermore, by an arrangement such as shown in FIG. 19, even when a plurality of gaming machines 10 are installed at locations of distances that do not enable the sending and receiving of data by a single cable from a plurality of servers 80 or even when a plurality of gaming machines are installed at locations that are separated from each other, the plurality of gaming machines 10 can be controlled in an integral manner via a public telephone line network or other communication line.

Also, the effects indicated in the present specification are just the most favorable effects arising from this invention, and the effects of this invention are not limited to those indicated in this specification.

With the present invention, by arranging a gaming machine, such as a so-called “bingo gaming machine,” in which cells of a matrix allocated to a player are made effective in accordance with a lottery, to have “a symbol allocation means, using the designs of a deck of playing cards as the above-mentioned symbols and allocating the symbols in all of the cells of the above-mentioned matrix; an outer peripheral cell shift means, shifting the symbol, displayed in one of the outer peripheral cells positioned adjacent to the outer periphery of the above-mentioned matrix, along the outer periphery of the above-mentioned matrix to an outer peripheral cell adjacent to the above-mentioned outer peripheral cell, at the same time shifting the symbol displayed in the above-mentioned adjacent outer peripheral cell along the above-mentioned outer periphery to yet another adjacent outer peripheral cell, and executing these processes on all outer peripheral cells so that for each of all outer peripheral cells, the symbol displayed in the outer peripheral cell is shifted to an outer peripheral cell adjacent to said outer peripheral cell; an inner peripheral cell shift means, shifting the symbol, displayed in one of the inner peripheral cells positioned inwardly adjacent to the above-mentioned outer peripheral cells in a region surrounded by all outer peripheral cells positioned adjacent to the outer periphery of the above-mentioned matrix, along the above-mentioned outer peripheral cells to an inner peripheral cell adjacent to the above-mentioned inner peripheral cell, at the same time shifting the symbol displayed in the above-mentioned adjacent inner peripheral cell along the above-mentioned cuter peripheral cells to yet another adjacent inner peripheral cell, and executing these processes on all inner peripheral cells so that for each of all inner peripheral cells, the symbol displayed in the inner peripheral cell is shifted to an inner peripheral cell adjacent to said inner peripheral cell; and a disbursement value determination means, carrying out a game using the matrix having symbols allocated in all of the above-mentioned cells by the above-mentioned symbol allocation means and, when all cells of a line, made up of cells that indicate a combination of symbols expressing a winning combination in a poker game, become effective, determining, in accordance with the above-mentioned winning combination, the magnitude of disbursement of game media or the multiplication factor of disbursement with respect to the quantity of game media betted by the above-mentioned player,” the fun of a “bingo game” of anticipating whether or not a line of effective cells will be completed can be combined with the fun of a “poker game” of changing the combinations of symbols displayed in effective cells to complete a winning combination along a line and change the quantity of game media disbursed upon completion of this line and the fun of a “puzzle game” of pondering how to shift the cells to form a winning combination by which a game media disbursement of high multiplication factor can be obtained, thereby enabling a new way of enjoying a game in which the aim is not just to complete any line among the plurality of lines in a given card in a “bingo game” but in which a winning combination can be completed by rearranging, according to rules, the symbols displayed on the card and the multiplication factor of disbursement with respect to the quantity of game media disbursed varies according to the winning combination of a completed line.

What is claimed is:

1. A gaming machine with which a combination-making game is performed, the combination-making game using a matrix which comprises five rows and five columns so as to contain a plurality of cells, wherein a symbol is allocated to each cell such that a cell becomes effective when a symbol corresponding to the cell is selected randomly by a lottery, and a predetermined benefit is provided to a player in accordance with a pattern of cells being effective after a predetermined number of lotteries, the gaming machine comprising:
a symbol allocation means for allocating a symbol to each cell of the matrix, the symbol being selected from a deck of playing cards;
an outer peripheral cell shift means for shifting each symbol of a peripheral group of cells of the matrix from an original cell position to an adjacent cell position such that a loop of symbols are shifted along the peripheral group of cells; and
a disbursement value determination means for determining amount of disbursement or a multiple number of a bet number of bets made by the player for disbursement depending on a predetermined rank of a combination of the combination-making game if all cells with allocated symbols along a line so as to make a winning combination in a poker game become effective after a predetermined number of lotteries are made with the matrix having symbols allocated to the respective cells thereof by said symbol allocation means.

2. The gaming machine according to claim 1, comprising; an inner peripheral cell shift means for shifting each symbol of an inner group of cells of the matrix from an inner original cell position to an inner adjacent cell position such that an inner loop of symbols are shifted along the inner group of cells.

3. A gaming machine with which a combination-making game is performed, the combination-making game using a matrix which comprises a plurality of rows and a same number of columns so as to contain a plurality of cells, wherein a symbol is allocated to each cell such that a cell becomes effective when a symbol corresponding to the cell is selected randomly by a lottery, and a predetermined benefit is provided to a player in accordance with a pattern of cells being effective after a predetermined number of lotteries, the gaming machine comprising:
a symbol allocation means for allocating a symbol to each cell of the matrix, the symbol being selected from a set of mahjong tiles;
an outer peripheral cell shift means for shifting each symbol of a peripheral group of cells of the matrix from an original cell position to an adjacent cell position such that a loop of symbols are shifted along the peripheral group of cells; and
a disbursement value determination means for determining amount of disbursement or a multiple number of a bet number of bets made by the player for disbursement depending on a predetermined rank of a combination of the combination-making game if all cells with allocated symbols along a line so as to make a winning combination become effective after a predetermined number of lotteries are made with the matrix having symbols allocated to the respective cells thereof by said symbol allocation means.

4. The gaming machine according to claim 3, comprising: an inner peripheral cell shift means for shifting each symbol of an inner group of cells of the matrix from an inner original cell position to an inner adjacent cell position such that an inner loop of symbols are shifted along the inner group of cells.

5. The gaming machine according to claim 1, wherein said symbol allocation means allocates the symbols to the cells of the matrix such that at least one winning combination of symbols are set in at least one line after the cell shift so that the predetermined benefit exceeding a predetermined standard is provided to the player.

6. The gaming machine according to claim 2, wherein said symbol allocation means allocates the symbols to the cells of the matrix such that at least one winning combination of symbols are set in at least one line after the cell shift so that the predetermined benefit exceeding a predetermined standard is provided to the player.

7. The gaming machine according to claim 3, wherein said symbol allocation means allocates the symbols to the cells of the matrix such that at least one winning combination of symbols are set in at least one line after the cell shift so that the predetermined benefit exceeding a predetermined standard is provided to the player.

8. The gaming machine according to claim 4, wherein said symbol allocation means allocates the symbols to the cells of the matrix such that at least one winning combination of symbols are set in at least one line after the cell shift so that the predetermined benefit exceeding a predetermined standard is provided to the player.

9. The gaming machine according to claim 1, comprising: a valid line determination means for determining a number of lines and locations thereof, wherein the disbursement of game media may be carried out when all cells aligned therein become effective.

10. The gaming machine according to claim 2, comprising: a valid line determination means for determining a number of lines and locations thereof, wherein the disbursement of game media may be carried out when all cells aligned therein become effective.

11. The gaming machine according to claim 3, comprising: a valid line determination means for determining a number of lines and locations thereof, wherein the disbursement of game media may be carried out when all cells aligned therein become effective.

12. The gaming machine according to claim 4, comprising: a valid line determination means for determining a number of lines and locations thereof, wherein the disbursement of game media may be carried out when all cells aligned therein become effective.

13. The gaming machine according to claim 1, comprising: a prior cell effective means for making at least one of the cells of the matrix in accordance with an effective lottery.

14. The gaming machine according to claim 2, comprising: a prior cell effective means for making at least one of the cells of the matrix in accordance with an effective lottery.

15. The gaming machine according to claim 3, comprising: a prior cell effective means for making at least one of the cells of the matrix in accordance with an effective lottery.

16. The gaming machine according to claim 4, comprising: a prior cell effective means for making at least one of the cells of the matrix in accordance with an effective lottery.

17. A gaming machine with which a combination-making game is performed, the combination-making game using a matrix which comprises a row with a row cell number of at least two and a column with a column cell number of at least two, wherein the row cell number equals the column cell number so as to constitute the matrix containing a plurality of cells, each of which has an allocated symbol such that each corresponding cell becomes effective if the allocated symbol to the corresponding cell is selected by a main lottery, the gaming machine being characterized to provide a benefit to a player depending on a pattern of cells being effective after a predetermined number of main lotteries, the gaming machine comprising:
a symbol allocation means for allocating a symbol to each cell of the matrix;
a cell shift means for shifting each symbol of a group of cells of the matrix from an original cell position to an adjacent cell position so as to rearrange the symbols such that at least one winning combination in at least one line of the matrix is arranged; and
a disbursement value determination means for determining amount of disbursement or a multiple number of a bet number of bets made by the player for disbursement depending on a predetermined rank of the combination of the combination-making game if all cells with allocated symbols along a line so as to make the winning combination become effective after the predetermined number of lotteries.

18. The gaming machine according to claim 17, wherein said cell shift means comprises a loop shifting means for shifting each symbol so as to be allocated to an adjacent cell such that a symbol shift chain makes a loop.

19. A program used in a gaming machine with which a combination-making game is performed, the combination-making game using a matrix which comprises a row with a row cell number of at least two and a column with a column cell number of at least two, wherein the row cell number equals the column cell number so as to constitute the matrix containing a plurality of cells, each of which has an allocated symbol such that each corresponding cell becomes effective if the allocated symbol to the corresponding cell is selected by a main lottery, the gaming machine being characterized to provide a benefit to a player depending on a pattern of cells being effective after a predetermined number of main lotteries, the gaming machine comprising:
a symbol allocation means for allocating a symbol to each cell of the matrix;
a cell shift means for shifting each symbol of a group of cells of the matrix from an original cell position to an adjacent cell position so as to rearrange the symbols such that at least one winning combination in at least one line of the matrix is arranged; and
a disbursement value determination means for determining amount of disbursement or a multiple number of a bet number of bets made by the player for disbursement depending on a predetermined rank of the combination of the combination-making game if all cells with allocated symbols along a line so as to make the winning combination become effective after the predetermined number of lotteries.

20. A server, connectable via a communication line to gaming machines, with each of which a combination-making game is performed, the combination-making game using a matrix which comprises a row with a row cell number of at least two and a column with a column cell number of at least two, wherein the row cell number equals the column cell number so as to constitute the matrix containing a plurality of cells, each of which has an allocated symbol such that each corresponding cell becomes effective if the allocated symbol to the corresponding cell is selected by a main lottery, each gaming machine being characterized to provide a benefit to a player depending on a pattern of cells being effective after a predetermined number of main lotteries, the server comprising:
a symbol allocation means for allocating a symbol to each cell of the matrix;
a cell shift means for shifting each symbol of a group of cells of the matrix from an original cell position to an adjacent cell position so as to rearrange the symbols such that at least one winning combination in at least one line of the matrix is arranged; and
a disbursement value determination means for determining amount of disbursement or a multiple number of a bet number of bets made by the player for disbursement depending on a predetermined rank of the combination of the combination-making game if all cells with allocated symbols along a line so as to make a winning combination become effective after the predetermined number of lotteries are made with the matrix.
